(19) United States
(12) Patent Application Publication
(10) Pub. No.: US 2024/0158925 A1
(43) Pub. Date: May 16, 2024

(54) A MEMBRANE-FREE ALKALINE ELECTROLYZER FOR UPCYCLING WASTE INTO AMMONIA

(71) Applicant: IOWA STATE UNIVERSITY RESEARCH FOUNDATION, INC., Ames, IA (US)

(72) Inventors: Wenzhen LI, Ames, IA (US); Yifu CHEN, Ames, IA (US); Hengzhou LIU, Ames, IA (US)

(21) Appl. No.: 18/485,096

(22) Filed: Oct. 11, 2023

Related U.S. Application Data
(60) Provisional application No. 63/415,133, filed on Oct. 11, 2022.

(51) Int. Cl. C25B 1/27; C25B 9/17; C25B 9/60; C25B 11/046; C25B 15/021; C25B 15/08

(52) U.S. Cl. CPC C25B 1/27; C25B 9/17; C25B 9/60; C25B 11/046; C25B 15/021; C25B 15/08

(57) ABSTRACT

The present disclosure relates to a membrane-free alkaline electrolyzer (MFAEL) system for converting nitrogen (N)-containing waste into ammonia (NH₃). The system includes a reaction medium comprising H₂O—NaOH—KOH; a pair of electrodes, wherein the electrodes are in contact with the reaction medium; and a power supply operably connected to the electrodes. Also disclosed is a method for converting nitrogen (N)-containing waste into ammonia (NH₃). This method involves introducing nitrogen (N)-containing waste into a membrane-free alkaline electrolyzer (MFAEL) system and applying current between the electrodes to perform oxidative and reductive transformation of the nitrogen (N)-containing waste into ammonia (NH₃).

This application claims the benefit of U.S. Provisional Patent Application Ser. No. 63/415,133, filed Oct. 11, 2022, which is hereby incorporated by reference in its entirety.

This invention was made with government support under grant number CHE2036944 awarded by the National Science Foundation. The government has certain rights in the invention.

### FIELD OF THE INVENTION

Disclosed herein is a membrane-free alkaline electrolyzer for upcycling waste into ammonia and methods for converting nitrogen (N)-containing waste into ammonia (NH₃).

### BACKGROUND OF THE INVENTION

As opposed to the “inert nitrogen (N₂)”, reactive nitrogen (Nr) is referred to as a variety of nitrogen-containing compounds that are active biologically, chemically, and/or photochemically. Nr is essential to life on earth as a basic building block of amino acids, proteins, nucleic acids, and other molecules necessary for life activities (Lehnert et al., Nat. Rev. Chem. 2:278-289 (2018); Kuypers et al., Nat. Rev. Microbiol. 16:263-276 (2018)). The global Nr generation has increased by ˜70% over the past 30 years, >60% of which can be attributed to the industry-driven anthropological N₂-fixing process (i.e., the Haber-Bosch process for ammonia (NH₃) synthesis) to fulfill the growing global food demand (Uwizeye et al., Nat. Food 1:437-446 (2020); Galloway and Cowling, Ambio 50:745-749 (2021)). The microbial decomposition-nitrification-denitrification process can turn Nr back to N₂ in nature, however, the generation rate of artificial Nr species is far greater than the elimination rate of those Nr species by natural processes (Fowler et al., Phil. Trans. R. Soc. B 368:20130164 (2013); Galloway et al., Science 320:889-892 (2008)), resulting in continued accumulation that has caused alarming and profound damage to ecosystems and human welfare (FIG. 1A and 2A) (Galloway et al., BioScience 53:341-356 (2003)). For example, the excessive Nr in major U.S. rivers from fertilization of crop fields (fertilizer runoff) and from food processing facilities (waste discharge) has been firmly linked to the seasonal eutrophication of the coastal areas, including the formation of notorious “dead zones” (Lehnert et al., Nat. Rev. Chem. 2:278-289 (2018)). In fact, most of the escaped Nr in the ecosystem ends up in the form of nitrate (NO₃⁻) because of its highest oxidation state. Excessive levels of nitrate-N (NO₃⁻—N) have been related to some severe human health hazards, including birth defects, blue baby syndrome, thyroid disease, and certain cancers if NO₃⁻—N levels are not properly treated in domestic water (Ward et al., Environ. Health Perspect. 113:1607-1614 (2005); Temkin et al., Environ. Res. 176:108442 (2019); Ward et al., Int. J. Environ. Res. Public Health 15:1557 (2018)). Therefore, restoring the balance between the generation and elimination of Nr (particularly NO₃⁻—N) is an important and urgent task for us today.

Sustainable solutions to this human-induced problem have been actively pursued in recent years, through processes of electrochemical reduction of NO₃⁻ (NO3RR). If NO₃⁻ in waste streams can be efficiently recovered and converted to NH₃ (eqn (1)), this NH₃-centric process will alleviate the environmental impacts of NO₃⁻, while substantially decreasing NH₃ demand from the Haber-Bosch process using fossil fuel-derived H₂ (van Langevelde et al., Joule 5:290-294 (2021); McEnaney et al., ACS Sustain. Chem. Eng. 8:2672-2681 (2020)):

NO₃⁻+2H₂O→NH₃+2O₂+OH⁻ (1)

Despite the successful development of some electrocatalysts for the NO₃⁻-to-NH₃ process in previous works (see Table 1 infra) (Deng et al., Adv. Sci. 8:2004523 (2021); Chen et al., Nat. Nanotechnol. 17:759-767 (2022); Hu et al., Energy Environ. Sci. 14:4989-4997 (2021); Gao et al., Nat. Commun. 13:2338 (2022); Li et al., Am. Chem. Soc. 142:7036-7046 (2020); Liu et al., Angew. Chem. Int. Ed. 61:e202202556 (2022)), many of them involve noble metals and/or require complicated synthetic procedures, making them less economically attractive, especially considering the electricity consumption for this 8-electron-transfer reaction. Moreover, NO₃⁻ is highly distributed with only tens or hundreds of ppm NO₃⁻—N in typical waste streams (van Langevelde et al., Joule 5:290-294 (2021)); thus, an efficient and sustainable concentrating step is another prerequisite for high-performance NH₃ electrosynthesis. Nevertheless, a systematic assessment of the technical and economic feasibility of NO₃⁻ concentration is critically missing in the current research field.

The present disclosure is directed to overcoming limitations in the art.

### SUMMARY OF THE INVENTION

One aspect of the present disclosure relates to a membrane-free alkaline electrolyzer (MFAEL) system for converting nitrogen (N)-containing waste into ammonia (NH₃). This system includes a reaction medium comprising H₂O—NaOH—KOH; a pair of electrodes, wherein the electrodes are in contact with the reaction medium; and a power supply operably connected to the electrodes.

Another aspect of the present disclosure relates to a method for converting nitrogen (N)-containing waste into ammonia (NH₃). This method involves introducing nitrogen (N)-containing waste into a membrane-free alkaline electrolyzer (MFAEL) system comprising a reaction medium comprising H₂O—NaOH—KOH; a pair of electrodes, wherein the electrodes are in contact with the reaction medium; and a power supply operably connected to the electrodes. A current is applied between the electrodes to perform oxidative and reductive transformation of the nitrogen (N)-containing waste into ammonia (NH₃).

The integrated sustainable process presented in the present disclosure provides an efficient approach to upcycling waste nitrogen, and extends to CO₂ capture from various sources, thanks to the basicity of ammonia. The synergistic combination of CO₂ capture and ammonia synthesis magnify the environmental benefits when adopted by real-world deployments. Owing to the flexibility and scalability of electrochemical systems, the distributed synthesis of green ammonia can also be realized from waste nitrogen sources, as opposed to the centralized synthesis of carbon-intensive methane-based ammonia manufacturing in Haber-Bosch plants. Findings on the conversion of organic nitrogen provide an alternative pathway for managing solid nitrogen-containing wastes for sustainable agriculture and environment. The unique ultra-alkaline NaOH/KOH/H₂O system employed in the present disclosure serves as an enabling electrolyte, inspiring other electrochemical conversions with tailored selectivity or activity.

The present disclosure describes an integrated electricity-driven process for economically upcycling waste nitrogen, which is enabled by low-concentration NO₃⁻ electrodialysis and high-performance NH₃ electrosynthesis from various Nr forms. As shown in FIG. 1C, the integrated electricity-driven process comprises the following three core components: (i) NO₃⁻ recovery from low-concentration waste streams by electrodialysis, (ii) Nr-to-NH₃ conversion by electrolysis, and (iii) formation of NH₃ and NH₃-based chemicals. Two optional components comprise a logical extension: a direct NH₃ fuel cell and NH₃-mediated bicarbonate electrolysis. In a membrane-free alkaline electrolyzer (MFAEL) with a NaOH/KOH/H₂O as the robust electrolyte, an NH₃ partial current density of 4.22±0.25 A cm⁻² from NO₃⁻ reduction with a faradaic efficiency (FE) of 84.5±4.9% was achieved on a simple commercial nickel foam as the cathode material. Low energy consumption was demonstrated to recover NO₃⁻ from low concentration (7.14 mM, or 100 ppm NO₃⁻—N) by efficient electrodialysis for the first time. The economic competitiveness was quantitatively analyzed for the combined process of NO₃⁻ recovery (by low-concentration electrodialysis) and NO₃⁻-to-NH₃ conversion (by high-performance electrolysis), as compared to the prevailing treatment methods of waste nitrogen. As one extension of the integrated process, continuous production of pure NH₃-based chemicals (NH₃ solution and solid NH₄HCO₃) was realized by collecting NH₃ in water and CO₂-saturated solutions, respectively, without the need for additional separation procedures. As another logical extension, pairing NO₃⁻ reduction on the cathode with the oxidation of organic Nr compounds on the anode led to NH₃ production from both electrodes simultaneously, realizing the convergent transformation of various Nr into NH₃ as the sole N-containing product. The integrated process described herein offers an all-sustainable and economically viable route for upcycling waste NO₃⁻—N into the highest-demanded N-based chemical product —NH₃, so that the growing trend of regional and seasonal Nr buildup could be largely decelerated and reversed.

### BRIEF DESCRIPTION OF THE DRAWINGS

FIGS. 1A-C show global N balance, N accessibility, and the presented integrated sustainable process. FIG. 1A shows a simplified annual balance of the global N cycle. Contribution of human activities to the fixation of N₂ is shown on top, while estimation of the rates of N₂ fixation (N₂ to Nr), denitrification (NO₃⁻ to N₂), and N₂O generation accompanied by denitrification is shown on the bottom. The numbers are in teragrams of N per year (Tg-N yr⁻¹) and were obtained from Fowler et al., Phil. Trans. R. Soc. B 368:20130164 (2013). FIG. 1B is a graph showing estimated amounts of freely accessible N element in different forms in the global ecosystem. Data are obtained from Kuypers et al., Nat. Rev. Microbiol. 16:263-276 (2018), which is hereby incorporated by reference in its entirety. Organic N, NO₃⁻, NH₃, and N₂O are the four most abundant forms of accessible Nr. FIG. 1C shows a schematic of the integrated sustainable process for upcycling waste nitrogen in the present disclosure, including NO₃⁻ recovery from low-concentration waste streams by electrodialysis, Nr-to-NH₃ conversion by electrolysis, and formation of NH₃-based chemicals (NH₄⁺ salts, pure NH₃ solution, and solid NH₄HCO₃). The use of the waste-derived NH₃ was demonstrated by two logical extensions: direct NH₃ fuel cell, and bicarbonate electrolysis with NH₄HCO₃. Abbreviations: CEM, cation-exchange membrane; AEM, anion-exchange membrane; BPM, bipolar membrane.

FIGS. 2A-B show a simplified representation of the N cycle. FIG. 2A is a schematic showing the current N cycle with a growing imbalance between N₂ and Nr. FIG. 2B is a schematic showing the proposed future NH₃-centric N cycle with enhanced Nr recycling, in which the NH₃ demand can be largely fulfilled by the conversion of existing Nr instead of the fixation of N₂. Through its utilization as an energy carrier (e.g., in fuel cells), NH₃ can be converted back to N₂, closing the N cycle. Abbreviations: N_{org}, organic Nr compounds. Note that the anthropological N₂ fixation and denitrification processes are both accompanied by the unavoidable emission of considerable greenhouse gases: each N atom fixed by the Haber-Bosch process results in the generation of 0.375 CO₂ molecules (from the steam reforming reactions); each NO₃⁻—N atom requires 0.83 molecules of CO₂ to be fully denitrified to the harmless N₂ (assuming methanol as the carbon source). By switching toward the renewable NH₃-centric N cycle, these CO₂ emissions should be largely mitigated.

FIGS. 3A-B show one embodiment of an MFAEL system of the present disclosure for NO3RR. FIG. 3A is a schematic diagram of one embodiment of a MFAEL system of the present disclosure and FIG. 3B is a photograph of one embodiment of an MFAEL system of the present disclosure.

FIGS. 4A-C show a convergent Nr-to-NH₃ process enabled by the MFAEL system of the present disclosure. FIG. 4A is a schematic illustration of one embodiment of a proposed concept, in which waste materials containing N—O bonds (inorganic wastes) and C—N bonds (organic wastes) are simultaneously converted to NH₃ in an MFAEL system of the present disclosure as the sole N-containing product. FIG. 4B is a graph showing screening test results for different forms of Nr. Electrolysis was carried out at 25 mA cm⁻² and 200° C. with 0.2 mmol of added N for each chemical, and NH₃ was collected every half hour until no significant increase in its production was detected. The y-axis (NH₃—N recovery) corresponds to the ratio of the produced NH₃—N to the initially added Nr—N. Each color block represents the NH₃ production from a half-hour period. The representative chemical structures of the Nr compounds are labeled on the top of the columns. Detailed reactant abbreviations, structures, and test results are summarized in Table 3 (infra). FIG. 4C shows production of and FE towards ¹⁴NH₃ and ¹⁵NH₃ during the paired electrolysis in one embodiment of a MFAEL containing both ¹⁵N—O and C—¹⁴N bonds. K¹⁵NO₃ (9.3 mmol) and alanine (18.7 mmol) were chosen as the model chemicals containing ¹⁵N—O and C—¹⁴N bonds, respectively. The produced ¹⁴NH₃ and ¹⁵NH₃ were quantified by ¹H NMR.

FIGS. 5A-C show thermodynamic calculations of NO3RR and hydrogen evolution reaction (“HER”) paired with oxygen evolution reaction (“OER”). All thermodynamic parameters were obtained from W. M. Haynes, CRC Handbook of Chemistry and Physics, CRC Press (2016), which is hereby incorporated by reference in its entirety. FIG. 5A is a graph showing dependence of thermodynamic cell voltage on temperature for different reactions, considering liquid (l) or gaseous (g) H₂O as the reactant, and aqueous (aq) or gaseous (g) NH₃ as the product. FIG. 5B is a graph showing a zoom-in view of FIG. 5A for NO3RR. FIG. 5C is a graph showing a comparison of thermodynamic cell voltage at different NH₃ partial pressures. 0.04465 and 0.004652 bars correspond to the NH₃ partial pressure in MFAEL operated at 5 A and 500 mA, respectively, assuming 200 mL min⁻¹ of the carrier gas flow rate and 100% faradaic efficiency towards NH₃. Note: the calculations show that NO3RR is much more favorable than HER under alkaline conditions, and the cell voltage decreases with increasing temperature. At temperature higher than 30° C., producing gaseous NH₃ is thermodynamically more favorable than aqueous NH₃. Liquid-phase H₂O as the reactant is thermodynamically more favorable than gaseous H₂O. Using a carrier gas to remove the produced NH₃ can shift the chemical equilibrium and thus make the reaction more thermodynamically favorable. These calculations justify the choice of reaction conditions in MFAEL: strong alkalinity to suppress HER; mildly elevated temperature with a continuous flow of carrier gas for the rapid evolution of gaseous NH₃; liquid water (40 wt. %) preserved in the electrolyte as the reactant.

FIGS. 6A-E show electrochemical NH₃ production by NO3RR in the NaOH/KOH/H₂O electrolyte in one embodiment of a MFAEL system of the present disclosure. FIG. 6A is a graph showing cell voltage profiles of the 2-hour NO3RR test at 5 A cm⁻² using two identical Ni mesh or Ni foam electrodes (1 cm² geometric area). FIG. 6B provides a comparison of the NO3RR performance in the system and method of the present disclosure with reported state-of-the-art performances. Data are summarized in Table 1 (ingra). The inset shows the scanning electron microscopy (“SEM”) image of the post-electrolysis Ni foam cathode. FIG. 6C shows a profile of online GC (with 99.999% Argon as the carrier gas) graphs during the 2-hour NO3RR test in MFAEL at 250 mA cm⁻². The retention time was 187 s for H₂, 248 s for O₂, and 278 s for N₂. Only a trace level of N₂ (˜400 ppmv) was detected throughout the electrolysis, corresponding to <1% FE towards N₂. Note that this value is close to the background concentration of N₂, confirming that NO3RR in the NaOH/KOH/H₂O electrolyte strongly favors the production of NH₃, and the N—N coupling pathway is inhibited. FIG. 6D is a graph showing LSV curves in the NaOH/KOH/H₂O electrolyte with 0.08 mol kg⁻¹ of added KNO₃ at different temperatures. The scan rate was 100 mV s⁻¹. FIG. 6E is a graph showing a comparison of NO3RR performance with different initial NO₃⁻ concentrations in the electrolyte. Note that the applied charge was equal to the theoretical charge required for the full conversion of the added KNO₃ into NH₃; therefore, at j=500 mA cm⁻², the electrolysis duration was 2 and 6 hours for the left and right columns, respectively.

FIGS. 7A-C show NO3RR in the NaOH/KOH/H₂O electrolyte at varying current densities on Ni-based electrodes. The left and right y-axis show the faradaic efficiency of NH₃ and the conversion of NO₃⁻, respectively. For all measurements, the amount of added KNO₃ was equal to the theoretical amount of NO₃⁻ that can be fully converted to NH₃ based on the applied charge. FIG. 7A is a graph showing a comparison of NO3RR performance using two identical Ni mesh and Ni foam as electrodes at 5 A cm⁻². The geometric area of the electrodes was 1 cm². FIG. 7B is a graph showing NO3RR performance for current densities in the range of 100-500 mA cm⁻². FIG. 7C is a graph showing NO3RR performance with 5 A of applied current with different areas of the Ni mesh electrodes. The same electrode area was used for both cathode and anode.

FIGS. 8A-B show NO3RR in the NaOH/KOH/H₂O electrolyte at temperatures ranging from 80 to 200° C. FIG. 8A is a graph showing cell voltage profiles of the 2-hour constant-current electrolysis for NO3RR at 250 mA cm⁻². FIG. 8B is a graph showing the corresponding faradaic efficiency of NH₃ and the conversion of NO₃⁻.

FIG. 9 is a graph showing control experiments of NO3RR in the NaOH/KOH/H₂O electrolyte. From left to right: 1^{st} column, with 46.64 mmol of added KNO₃ and 5 A cm⁻² of applied current density. 2^{nd} column, with 46.64 mmol of added KNO₃ and no applied current. 3^{rd} column, with 5 A cm⁻² of applied current density and no added KNO₃. 4^{th} column, with 46.64 mmol of added KNO₃ and 200 mL min⁻¹ of H₂ feed, and no applied current. The reaction time was 2 h for all 4 experiments.

FIGS. 10A-D show a comparison of the results of NH₃ quantification by indophenol colorimetry (FIG. 10A), ¹H NMR (FIG. 10B), and ion chromatography (FIG. 10C). The squares represent the calibration solutions, and the circles represent the sample solution. The sample solution was obtained from NO3RR in the NaOH/KOH/H₂O electrolyte at 5 A (500 mA cm⁻²) for 2 hours. Note that the 3 methods require different folds of dilution to satisfy their measurement ranges (colorimetry: 5,120-fold; ¹H NMR: 2,560-fold; ion chromatography: 80-fold). FIG. 10D is a graph showing a comparison of the calculated Faradaic efficiency (“FE”) towards NH₃ determined by different methods.

FIG. 11 is a graph showing Faradaic efficiency (FE) of H₂ for NO3RR in the NaOH/KOH/H₂O electrolyte at 250 mA cm⁻² determined by online GC. The average FE towards H₂ during 2-hour NO3RR electrolysis was 5.35%. This agrees well with the high FE of NH₃ (92.2%) under this condition, suggesting that HER in the NaOH/KOH/H₂O electrolyte is largely suppressed in the presence of NO₃⁻. FE towards H₂ decreased in the initial period of electrolysis, which could be due to the formation of nanostructured Ni on the cathode. The increase in FE(H₂) after 80 min is because of the consumption of NO₃⁻ (the overall NO₃⁻ conversion was 95.5%).

FIG. 12 is a graph showing NH₃ FE and NO₃⁻ conversion of NO3RR in the NaOH/KOH/H₂O electrolyte at 500 mA cm⁻² with different carrier gases. Air was pre-scrubbed in 0.1 M KOH to remove trace CO₂ before entering the MFAEL.

FIGS. 13A-C show NO3RR in a divided H-type cell system. The cathode and anode chambers were separated by a PTFE mesh (0.025″×0.005″ opening) to prevent the gas crossover. KNO₃ was initially added to the cathode chamber, and electrolytes in both chambers were bubbled with 100 mL min⁻¹ of N₂ as the carrier gas into two separate H₂SO₄ absorbing solutions; other operating conditions were kept the same as the undivided MFAEL reactor. FIG. 13A is a photograph of the divided cell system. FIG. 13B is a graph showing the cell voltage profiles of the 2-hour constant-current electrolysis at 250 mA cm⁻². FIG. 13C is a graph showing the distribution of the reactant and products from the cathode and anode chambers. At 250 mA cm⁻², the divided cell that is free of gas crossover produced NH₃ at the same level of high FE (86.7%) as the undivided MFAEL reactor (92.2%). The cell voltage was higher compared to the undivided reactor due to the separator and the larger distance between the electrodes. The vast majority of produced NH₃ was collected from the cathode side, suggesting the rapid evolution of NH₃ from the NaOH/KOH/H₂O electrolyte.

FIGS. 14A-D show the effect of electrolyte composition on the NO3RR performance in MFAEL. For the ternary NaOH/KOH/H₂O electrolyte, 40, 91, and 99 wt. % of water correspond to 15, 2 M, and 0.2 M OH⁻, respectively. FIG. 14A is a graph showing a comparison of NO3RR performance at 100 mA cm⁻² in the ternary electrolyte (NaOH/KOH/H₂O with 1:1 molar NaOH/KOH) and binary electrolytes (NaOH/H₂O and KOH/H₂O). The OH⁻ concentration was 15 M for the ternary and binary electrolytes. FIG. 14B is a graph showing a comparison of NO3RR performance in the ternary NaOH/KOH/H₂O electrolyte with different alkalinity. FIG. 14C is a graph showing the distribution of produced NH₃ in the MFAEL systems with different alkalinity after 2-hour electrolysis. The differently shaded portions of the columns in the graph show the percentage of NH₃ detected in the absorbing solution and the electrolyte, respectively. FIG. 14D is a graph showing NO3RR in the 2 M electrolyte with different alkalis. With increased water content, more NH₃ was retained in the electrolyte instead of being carried out by the flow of carrier gas. In the measurements, the system was kept with gas bubbling for an additional 30-minute period after electrolysis, which was found to be sufficient to deplete the remaining NH₃ in the electrolyte with 40 wt. % of water.

FIGS. 15A-F are SEM images of Ni mesh electrodes. FIG. 15A shows bare Ni mesh before electrolysis. FIG. 15B shows Ni mesh cathode and FIG. 15C shows Ni mesh anode after NO3RR measurement in the NaOH/KOH/H₂O electrolyte at 5 A cm⁻². FIGS. 15D-F show the corresponding images of FIGS. 15A-C at higher magnification. From the SEM images, no considerable structural change was observed for the anode after electrolysis in the NaOH/KOH/H₂O electrolyte. The cathode surface shows some nanostructured features, which is a combination of ˜100 nm particles and hexagonal flakes with diameter of 1-2.5 μm.

FIG. 16 shows a photograph of the bare Ni mesh electrode (left) and the post-electrolysis Ni mesh cathode (right).

FIGS. 17A-F show scanning electron microscopy/energy dispersive spectroscopy (“SEM-EDS”) analysis of Ni mesh electrodes. FIG. 17A is an SEM image of the post-electrolysis Ni mesh cathode. FIGS. 17B-C are SEM images showing the corresponding elemental mappings of Ni and O, respectively. FIG. 17D shows energy dispersive spectroscopy (“EDS”) of the entire region (sum) and two selected areas of FIG. 17A. FIG. 17E shows EDS of the bare Ni mesh and the post-electrolysis Ni mesh cathode. FIG. 17F is a table showing atomic percentages (at. %) of different elements for the bare and post-electrolysis Ni mesh electrodes determined by SEM-EDS. SEM-EDS shows a considerable increase in O content for the Ni cathode after electrolysis in the NaOH/KOH/H₂O electrolyte, but only a slight increase for the anode. The ˜100 nm particles and 1-2.5 μm hexagonal flakes correspond to nickel oxides with different degrees of oxidation with Ni/O ratios of 3.66 and 0.72, respectively.

FIGS. 18A-D show SEM images of Ni foam electrodes. FIG. 18A shows bare Ni foam before electrolysis. FIG. 18B shows Ni foam cathode after NO3RR measurement in the NaOH/KOH/H₂O electrolyte at 5 A cm⁻². FIGS. 18C-D show the corresponding images of FIGS. 18A-B at higher magnification.

FIGS. 19A-E show SEM-EDS analysis of the post-electrolysis Ni foam cathode. FIG. 19A is an SEM image of the post-electrolysis Ni foam cathode. FIGS. 19B-C are SEM images showing the corresponding elemental mappings of Ni and O, respectively. FIG. 19D shows EDS of the entire region (sum) and two selected areas of FIG. 19A. FIG. 19E is a table showing the atomic percentages (at. %) of different elements for the post-electrolysis Ni foam cathode determined by SEM-EDS.

FIGS. 20A-D show characterization of Ni electrodes before and after electrolysis in the H₂O/NaOH/KOH electrolyte. FIG. 20A shows XRD patterns of the bare Ni mesh and post-electrolysis Ni mesh electrodes. FIG. 20B shows Raman spectra of the bare Ni foam and post-electrolysis Ni foam electrodes. FIGS. 20C-D show Ni 2p XPS spectra of the bare Ni foam (FIG. 20C) and post-electrolysis Ni foam (FIG. 20D) electrodes. For the post-electrolysis cathode, no emerging XRD peaks of nickel oxides or hydroxides were observed. Raman spectra show weak but identifiable signals at 450 and 3580 cm⁻¹, corresponding to the stretching modes of Ni—OH and O—H bonds, respectively (Hall et al., Proc. Math. Phys. Eng. Sci., 471:20140792 (2015), which is hereby incorporated by reference in its entirety). XPS spectra show the apparent transformation from a mixture of metallic Ni and its oxides/hydroxides for the bare Ni foam surface, to a hydroxide-only surface for the post-electrolysis Ni foam cathode. These observations strongly suggest the formation of a Ni(OH)₂ layer on the Ni cathode surface after electrolysis in the NaOH/KOH/H₂O electrolyte.

FIGS. 21A-F show the measurement of roughness factor (RF) of Ni mesh (FIGS. 21A-B) and Ni foam (FIGS. 21C-D) cathodes before and after electrolysis in the NaOH/KOH/H₂O electrolyte by cyclic voltammetry in 1 M KOH. FIGS. 21E-F are graphs showing the corresponding capacitive currents at different scan rates for Ni mesh (FIG. 21E) and Ni foam (FIG. 21F) cathodes. The capacitive currents at −0.15 V vs. Ag/AgCl were used for RF calculation. From the slope of FIG. 21E and FIG. 21F, it was found that after electrolysis in the NaOH/KOH/H₂O electrolyte, the RF increases by 1.11 and 1.69 times for the Ni mesh and Ni foam cathode, respectively.

FIGS. 22A-B show SEM images of Cu mesh electrodes. The anode was a Ni mesh electrode. FIG. 22A shows bare Cu mesh before electrolysis. FIG. 22B shows a Cu mesh cathode after NO3RR measurement in the NaOH/KOH/H₂O electrolyte at 5 A cm⁻². XRD patterns of the bare Ni mesh and post-electrolysis Ni mesh electrodes.

FIGS. 23A-E show SEM-EDS analysis of the post-electrolysis Cu mesh cathode. The anode was a Ni mesh electrode. FIG. 23A shows an SEM image of the post-electrolysis Cu mesh cathode. FIGS. 23B-D show the corresponding elemental mappings of Cu, Ni, and O, respectively. FIG. 23E shows EDS of the entire region (sum) of FIG. 23A. SEM imaging and EDS suggest the deposition of nanostructured NiOₓ on the Cu mesh cathode after electrolysis in the NaOH/KOH/H₂O electrolyte. The Ni content on the post-electrolysis Cu mesh surface was 18.4 at. % (determined by SEM-EDS). Therefore, formation of the cathodic nanostructure should be attributed to the migration of Ni from anode to cathode during the electrolysis.

FIGS. 24A-C show a comparison of NO3RR on Ni foam cathode with different anodes. FIGS. 24A-B show SEM images of the post-electrolysis Ni foam cathode with Ni foam (FIG. 24A) and graphite rod (FIG. 24B) as the anode. FIG. 24C is a graph showing NH₃ FE at 5 A cm⁻² on Ni foam cathode with different anodes. The diameter of the graphite rod was ¼″, and its active area in the electrolyte was ˜8.9 cm².

FIGS. 25A-C show electrochemical NH₃ production by NO3RR in one embodiment of a scaled-up MFAEL system. FIG. 25A is a photograph of the scaled-up MFAEL system with a reactor capacity of 2.5 L. FIG. 25B is a photograph of the cell cap for the scaled-up MFAEL reactor. FIG. 25C is a photograph of the post-electrolysis Ni mesh electrodes. The darker color of the cathode suggests the formation of nanostructured NiOₓ as a similar observation to the 100 mL reactor (FIG. 16).

FIGS. 26A-C show obtaining pure NH₃-based chemicals by using different absorbing solutions for the MFAEL system. FIG. 26A is a graph showing NH₃ collection efficiency for different absorbing solutions (100 mL for each): 0.5 M H₂SO₄, CO₂-saturated water (5° C.), and water (5° C.). The collection efficiency was determined by bubbling the outlet gas of the absorbing solution into an acidic solution (0.1 M H₂SO₄), and determining the ratio of NH₃ content between the absorbing solution and the acidic solution. Note that the NH₃ concentration in CO₂-saturated solutions was quantified by ¹H NMR due to the pH-sensitive nature of the colorimetric method. FIGS. 26B-C are photographs of the NH₄HCO₃ precipitate (FIG. 26B) and obtained powder product (FIG. 26C) by feeding the outlet gas from the scaled-up MFAEL into CO₂-saturated water at 5° C.

FIGS. 27A-C show production of pure NH₃-based chemicals in one embodiment of a scaled-up MFAEL system. FIG. 27A is a graph showing the cell voltage profile for the scaled-up MFAEL system in a 24-hour NO3RR test at 25 A. Note that the steps in the voltage profile are due to the minimum resolution of the DC power supply (0.1 V) at the large current rating (30 A). FIG. 27B is a graph showing polarization and power density curves for the fuel cells with MFAEL-derived NH₃ solution and commercial NH₃ solution (with the same concentration) as the anode fuel. The fuel cell was operated at 80° C., and 1.25 M KOH was added to the NH₃ solutions. FIG. 27C shows XRD patterns of the MFAEL-derived NH₄HCO₃ solid and a commercial NH₄HCO₃ product. The inset photo shows the collected NH₄HCO₃ product (74.2 g) from 24-hour electrolysis in a scaled-up MFAEL.

FIG. 28 shows one embodiment of an NH₃ fuel cell configuration, including end plates (1, 1′), current collectors (2, 2′), flow-field plates (3, 3′), gaskets (4, 4′), anode gas diffusion layer (5, PtIr/C on hydrophilic carbon cloth), cathode gas diffusion layer (5′, Pt/C on carbon paper), and anion-exchange membrane (6, Tokuyama A201).

FIGS. 29A-B show working principles of NO₃⁻ concentrating and an experimental electrodialysis system. FIG. 29A provides a schematic illustration of the working principles of NO₃⁻ concentrating via electrodialysis with one electrodialysis pair (CEM|diluate solution|AEM|concentrate solution), and one additional CEM (part of background cell). FIG. 29B is a photograph of the experimental electrodialysis system in operation encompassing one electrodialysis cell, two peristaltic pumps, and three solution containers (diluate, concentrate, and electrode solutions).

FIGS. 30A-B show an investigation of the reaction products of the conversion of organic Nr compounds in the NaOH/KOH/H₂O electrolyte by ¹³C NMR. Electrolysis was carried out with ¹³C-labeled chemicals (4.2 mmol for glycine, or 6.7 mmol for alanine) for 1 h. FIG. 30A provides NMR spectra of the electrolyte after reaction with different ¹³C-labeled reactants: (1) glycine-2-¹³C, (2) alanine-3-¹³C, and (3) alanine-1-¹³C. FIG. 30B shows the identified half-reaction equations for (1)-(3). The isotopically labeled ¹³C atoms are shaded, and the bond cleavages are represented by the dashed lines.

FIGS. 31A-D show conversion of organic Nr compounds in the NaOH/KOH/H₂O electrolyte under different operating conditions. All tests were carried out for 2 h under the conditions specified in the figures. Oxalate production was determined by HPLC. FIG. 31A is a graph showing FE towards NH₃ and oxalate at different current densities with glycine as the reactant. FIG. 31B is a graph showing the effect of alkalinity (water content) on the production of NH₃ and oxalate from glycine. FIG. 31C is a graph showing NH₃ production from the conversion of glycine, alanine, and β-alanine. FIG. 31D is a graph showing control experiments with 18.7 mmol of glycine as the reactant in the NaOH/KOH/H₂O electrolyte. From left to right: 1^{st} column, with 100 mA cm⁻² of applied current density. 2^{nd} column, without applied current. 3^{rd} column, with 200 mL min⁻¹ of O₂ feed, and no applied current. These results suggest that under the operating conditions of MFAEL, the ratio of NH₃ and oxalate production is close to 1, agreeing with the results from ¹³C NMR (FIGS. 30A-B). High alkalinity and electricity are indispensable for the efficient conversion of C—N bonds, and process is not an O₂-mediated non-faradaic process. The secondary amine (alanine) shows higher NH₃ production rate than the primary amine (glycine), and amine groups at α-C (such as amino acids) are much more reactive compared to those with longer carbon chains (such as β-alanine). These trends agree with the screening test results at 200° C. (FIG. 4B and Table 3).

FIGS. 32A-C show electrolysis in the NaOH/KOH/H₂O electrolyte with a commercial protein powder (Orgain). The content of N is 8.90 wt. % (determined by a combustion elemental analyzer). The reaction time was 2 h. FIG. 32A is a graph showing NH₃ production with and without 100 mA cm⁻² of applied current density. FIG. 32B is a graph showing HPLC graphs of the electrolyte after reaction with and without 100 mA cm⁻² of applied current density. FIG. 32C is a schematic showing the suggested pathway for the conversion of different forms of Nr to NH₃ in the NaOH/KOH/H₂O electrolyte. The protein powder sample contains various forms of Nr. As it was added into the electrolyte in MFAEL, NH₃ evolves instantly without applying current. As shown in the first step in FIG. 32C, production of this NH₃ (colored green) should be contributed to the hydrolysis reaction of low-valent N (NH₄⁺ ions and primary amide groups) in the sample, which occurs readily under the MFAEL operating conditions (high alkalinity and elevated temperature). Comparing the NH₃ production with and without applied current, it was found that electricity boosted the total NH₃ production by 33%, which is due to the oxidation of Nr in amino acids. Meanwhile, the carboxylic acid product (oxalate as identified in HPLC) is produced only with an applied current, verifying that the oxidation-assisted NH₃ production (by the cleavage of C—N bonds) requires the participation of electricity (colored red in FIG. 32C).

FIGS. 33A-B show detection of O₂ for the conversion of organic Nr in the NaOH/KOH/H₂O electrolyte by online GC. Helium gas was used as the carrier gas for both MFAEL and GC. FIG. 33A shows GC graphs with thermal confuctivity detector (“TCD”) during the electrolysis with alanine, while FIG. 33B shows GC graphs with thermal confuctivity detector (TCD) during the electrolysis with KNO₃. Production of O₂ from the OER is apparently suppressed in the presence of organic Nr (alanine), while it remains stable in the absence of organic Nr.

FIGS. 34A-C show detection of volatile carbon-containing products for the conversion of organic Nr in the NaOH/KOH/H₂O electrolyte by online GC. Helium gas was used as the carrier gas for both MFAEL and GC. FIG. 34A shows GC graphs with flame ionization detector (FID) during the electrolysis with alanine, while FIG. 34B shows GC graphs with flame ionization detector (FID) during the electrolysis with protein powder. FIG. 34C shows a GC graph of the standard 1% gas mixture of CO, CH₄, CO₂, C₂H₂, and C₂H₆ (in N₂ balance), with the same zoom scale as FIGS. 34A-B. Despite its ppm-level sensitivity, no known volatile carbon-containing product was detected by FID during the conversion of organic Nr indicating that carbon is retained in the electrolyte.

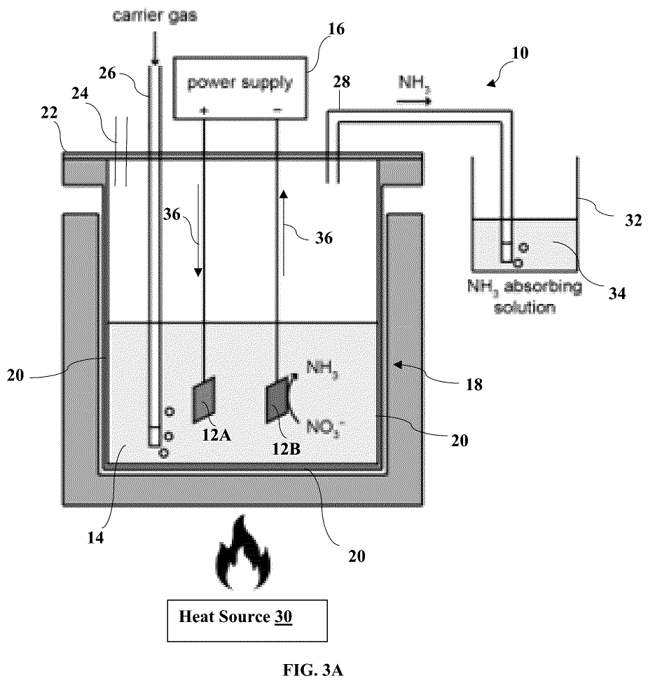

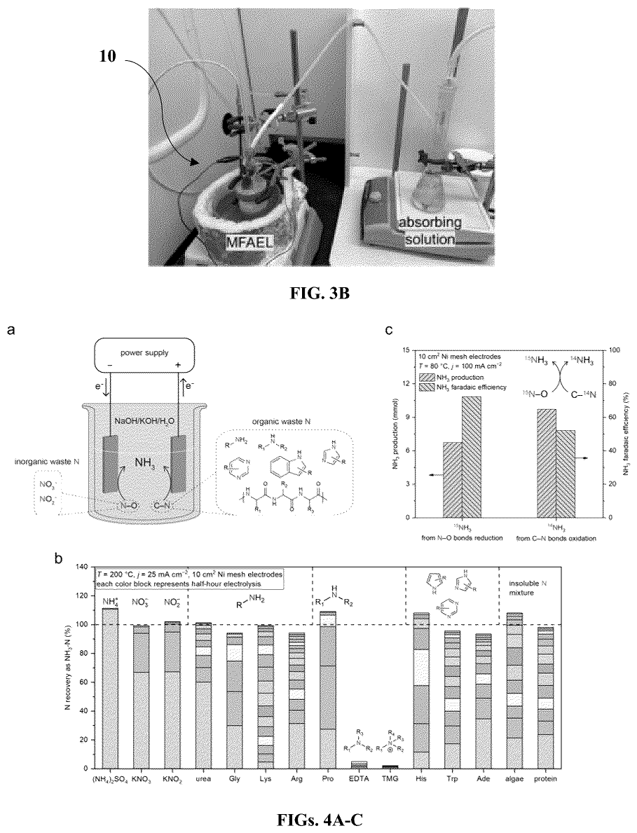

FIGS. 3 5A-D show electrolysis with different Nr compounds containing N—O or C—N bonds. KNO₃ (9.3 mmol) and alanine (18.7 mmol) were chosen as the model chemicals containing N—O and C—N bonds, respectively. The reaction time was 2 h. FIG. 35A is a graph showing LSV curves for the NaOH/KOH/H₂O electrolyte containing different forms of Nr. FIG. 35B is a graph showing NH₃ FE for the electrolysis in the NaOH/KOH/H₂O electrolyte with different added Nr compounds. From left to right: 1^{st} column, containing N—O bonds only; 2^{nd} column, containing C—N bonds only; 3^{rd} column, containing both N—O and C—N bonds. FIG. 35C is a graph showing a comparison of NH₃ production determined by ¹H NMR and colorimetry at different stages of electrolysis for the system containing ¹⁵N—O and C—¹⁴N bonds. FIG. 35D shows NH₃ production with and without 100 mA cm⁻² of applied current density from the NaOH/KOH/H₂O electrolyte containing both N—O and C—N bonds. ¹H NMR suggested that NH₃ comes from the cleavage of both N—O and C—N bonds. Comparison of different quantification methods shows the accuracy of both ¹H NMR and colorimetry methods. The minor difference in total NH₃ production is due to the systematic error in the NMR peak deconvolution. Compared to the system with only one added component, the FE of NO3RR slightly decreases (84.0% vs. 72.3%), while the FE of alanine oxidation increases considerably (12.3% vs. 52.1%). Such a synergetic effect for the paired system is possibly due to the difference in electrode potentials (as seen in the LSV curves), or because the suppression of certain side reactions (such as HER or OER) could affect the reaction pathway towards NH₃ by stabilizing or destabilizing the reaction intermediates.

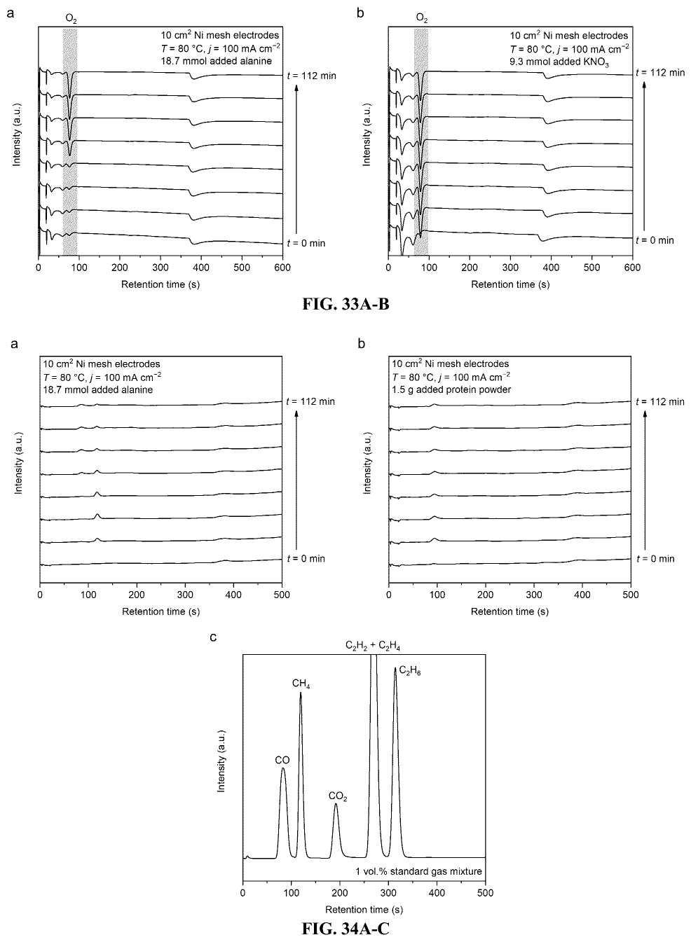

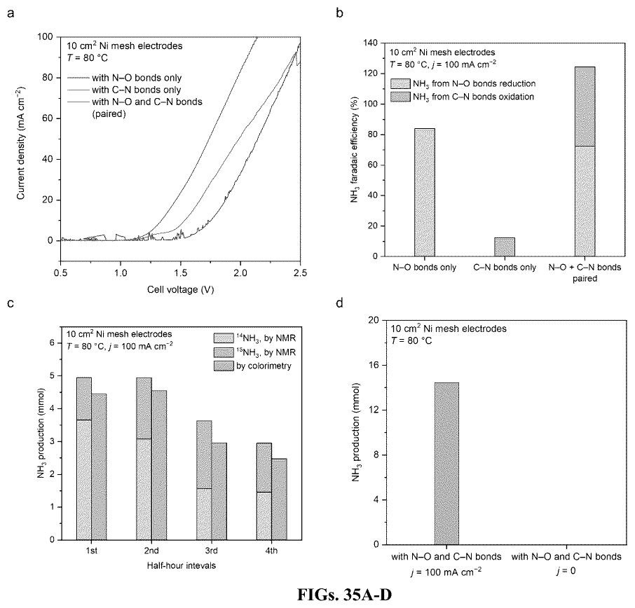

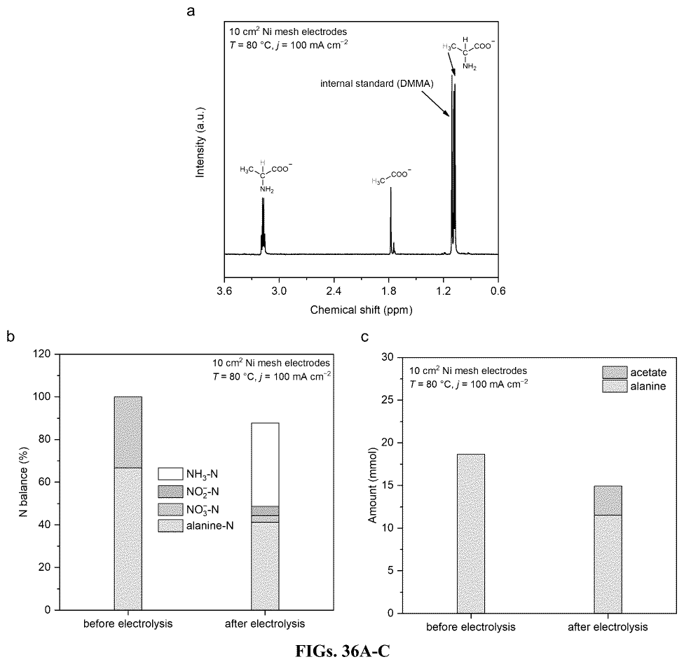

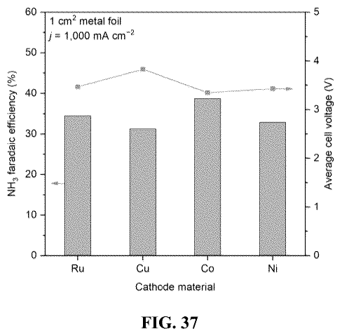

FIGS. 36A-C show quantification of carbon and nitrogen-containing products for the paired electrolysis with KNO₃ and alanine in the NaOH/KOH/H₂O electrolyte. FIG. 36A provides the ¹H NMR spectrum of the electrolyte after reaction, showing the protons in the reactant alanine and product acetate. FIG. 36B shows balance of the nitrogen element. FIG. 36C shows a comparison of the total amount of alanine and acetate before and after electrolysis. Note: before electrolysis, 18.66 mmol of alanine (C₃H₇NO₂) and 9.33 mmol of NO₃⁻ were added to the system; after electrolysis, 11.52 mmol of alanine (C₃H₇NO₂), 3.41 mmol of acetate (CH₃COO⁻), 0.87 mmol of NO₃⁻, and 1.23 mmol of NO₂⁻ were detected in electrolyte; and 10.94 mmol of NH₄⁺ was detected in the absorbing solution. CO₃²⁻ in the electrolyte was unable to be quantified, and it is assumed that its production follows the chemical equation in FIGS. 36A-B (1:1 molar acetate and CO₃²⁻), which is supported by the qualitative ¹³C NMR measurement taken. These results suggest that this system has the carbon and nitrogen elemental balance of ≥80%. None of the volatile carbon-containing products (CO, CH₄, CO₂, C₂H₄, C₂H₂, and C₂H₆) was detected by gas chromatography throughout the electrolysis (FIGS. 34A-C). Therefore, the unbalanced portion of the carbon and nitrogen could be due to the possible intermediate species unidentified by ¹H NMR, apart from the cumulative measurement errors. Also, further oxidation of acetate to CO₃²⁻ could occur, resulting in the lower apparent carbon balance value. Below are the balances for nitrogen and carbon elements:
The balance for nitrogen element is: (11.52+0.87+1.23+10.94)÷(18.66+9.33)=87.8%
The balance of carbon element is: (11.52×3+3.41×2+3.41×1)÷(18.66×3)=80.0%

FIG. 37 is a graph showing a comparison of NO3RR performance on different metal foil cathodes in the NaOH/KOH/H2O electrolyte. For a fair comparison, the dimensions of the metal foils were kept identical exactly as 1×1 cm² and 1 mm thickness. A graphite rod (˜8.9 cm²) was used as the anode to avoid the impact of re-deposited metal species dissolved from the anode. The applied current was 1,000 mA. The FE towards NH₃ on four metal foils shows the following trend: Co>Ru>Ni>Cu; and for the average cell voltage: Co<Ni<Ru<Cu. Note that the performance was lower on these metal foils than mesh and foam electrodes, because of the significantly limited surface area available for electrochemical reaction. These results suggest that future development of cathode materials could further improve the cell performance.

### DETAILED DESCRIPTION OF THE INVENTION

The present disclosure relates to systems and methods of electrolysis for converting nitrogen (N)-containing waste into ammonia (NH₃). Electrolysis is a process where electrical current is used to drive a non-spontaneous redox reaction.

One aspect of the present disclosure relates to a membrane-free alkaline electrolyzer (MFAEL) system for converting nitrogen (N)-containing waste into ammonia (NH₃). The system includes a reaction medium comprising H₂O—NaOH—KOH; a pair of electrodes, wherein the electrodes are in contact with the reaction medium; and a power supply operably connected to the electrodes.

The term “electrolyzer,” as used herein, refers to an apparatus, device, container, or system for performing electrolysis. In some embodiments, an electrolyzer has a pair of electrodes (e.g., an anode and a cathode), a reaction medium (e.g., an electrolyte solution), and a power supply, which is typically an external source of power to add electrical energy to a reaction taking place in the reaction medium. The electrodes facilitate the transfer of electrical energy into the reaction medium by extending into the reaction medium at one end and connecting to an external power supply at the other end. One particular type of electrolyzer is an alkaline electrolyzer. In an alkaline electrolyzer, the reaction medium or electrolyte solution typically includes sodium hydroxide and/or potassium hydroxide and water. A membrane-free electrolyzer typically has only one compartment containing the reaction medium, as opposed to an electrolyzer with a reaction medium separated, at least partially, by a membrane. The membrane may divide the reaction chamber into two compartments, with one compartment containing one of the electrodes and the other compartment containing the other electrode of the electrode pair. In some embodiments of a membrane-free electrolyzer, the reaction medium is a single chamber and the two electrodes of the electrode pair are both present in the reaction chamber without any physical separation or barrier between them. For example, the electrode pair is typically only separated by space in a reaction medium and/or chamber.

One embodiment of a membrane-free alkaline electrolyzer (MFAEL) system of the present disclosure is illustrated in FIG. 3A. As illustrated, MFAEL 10 includes a pair of electrodes 12A and 12B, which extend into reaction medium or electrolyte solution 14, and each electrode 12A and 12B are shown connected to power supply 16 (i.e., anode, positive electrode 12A connected to the positive terminal “+” of the power supply and cathode, negative electrode 12B connected to the negative terminal “−” of the power supply) and extending into reaction medium 14 contained in single reaction chamber 18, defined by chamber walls 20. Current 36 from power supply 16 enters reaction medium 14 through anode 12A and exits reaction medium 14 through cathode 12B.

As used herein, “nitrogen (N)-containing waste” refers to waste material that comprises reactive nitrogen (Nr) species, including but not limited to nitrates, nitrogen-containing organic compounds, nitrous oxide, nitrites, and other nitrogen oxides. Reactive nitrogen includes a variety of nitrogen-containing compounds that are active biologically, chemically, and/or photochemically.

In some embodiments, the membrane-free alkaline electrolyzer (MFAEL) system of the present disclosure can be used to convert nitrogen (N)-containing waste into ammonia (NH₃).

Thus, another aspect of the present disclosure relates to a method for converting nitrogen (N)-containing waste into ammonia (NH₃). This method involves introducing nitrogen (N)-containing waste into a membrane-free alkaline electrolyzer (MFAEL) system comprising a reaction medium comprising H₂O—NaOH—KOH; a pair of electrodes, wherein the electrodes are in contact with the reaction medium; and a power supply operably connected to the electrodes. A current is applied between the electrodes to perform oxidative and reductive transformation of the nitrogen (N)-containing waste into ammonia (NH₃).

In some embodiments, the method of converting nitrogen (N)-containing waste into ammonia (NH₃) is carried out using a system described herein.

In some embodiments of the systems and methods disclosed herein, the electrodes are formed of a material comprising Ni, Co, Ru, Cu, and mixtures thereof. In some embodiments, the electrodes are formed of a material comprising Ni. In some embodiments, the electrodes are Ni electrodes. In some embodiments, the Ni electrodes are made from or comprise foam and/or mesh material. In some embodiments, the electrodes comprise foam material. In some embodiments, the electrodes comprise mesh material. In some embodiments, the electrodes comprise a mixture of foam material and mesh material. The pair of electrodes can be the same material or different materials.

In some embodiments, the nitrogen (N)-containing waste, which is converted to ammonia (NH₃) using the systems and methods described herein, is selected from nitrate, nitrite, urea, amino acids, proteins, and mixtures thereof.

In some embodiments of the systems and methods disclosed herein, the reaction medium of the membrane-free alkaline electrolyzer (MFAEL) comprises H₂O—NaOH—KOH, with the H₂O component being present in the reaction medium in an amount of about 40 wt. %, or 35 wt. % to 45 wt. %, including 35 wt. %, 36 wt. %, 37 wt. %, 38 wt. %, 39 wt. %, 41 wt. %, 42 wt. %, 43 wt. %, 44 wt. %, 45 wt. %, or any amount or range therein, or any other amount or range in which the system and/or method is able to convert nitrogen (N)-containing waste, which is converted to ammonia (NH₃).

In some embodiments of the systems and methods disclosed herein, the reaction medium comprises equimolar amounts of NaOH and KOH, although non-equal molar amounts of NaOH and KOH may also be used. For example and without limitation, non-equal molar amounts of NaOH and KOH may include a variance between the amount of NaOH and KOH of 1%, 2%, 3%, 4%, 5%, 10%, 15%, 20%, 25%, or more.

In some embodiments, the reaction chamber is defined by chamber walls to form a leak-free reaction chamber, such as a glass container or other structure that is leak proof In some embodiments, the chamber walls forming the reaction chamber are constructed of polytetrafluoroethylene (PTFE). In some embodiments, the reaction chamber is an open top reaction chamber, having a bottom and side walls. In some embodiments, the reaction chamber comprises a lid or a cap to cover an open top, such as stainless-steel cap. For example, and with reference again to FIG. 3A, MFAEL 10 includes lid or cap 22, which is shown above vertical chamber walls 20. Cap 22 may or may not form a seal with vertical chamber walls 20, such that cap 22 either forms a partially closed or completely closed reaction chamber 18.

In some embodiments, the reaction chamber comprises a liquid injection conduit or port through which liquid pertaining to the reaction medium or nitrogen (N)-containing waste is added to the reaction medium of the electrolyzer. In some embodiments of the methods described herein, water and/or nitrogen (N)-containing waste is added into the reaction chamber via the liquid injection conduit. With further reference to FIG. 3A, injection conduit (or port) 24 is shown penetrating cap 22 to allow a liquid to pass through injection conduit 24 and into reaction chamber 18.

In some embodiments of the systems disclosed herein, the reaction chamber further comprises an air intake conduit and an exit conduit. In some embodiments, the methods described herein are carried out by adding air and/or N₂ into the reaction medium via the air intake conduit and removing ammonia (NH₃) from the reaction medium via the exit conduit. With reference to FIG. 3A, air intake conduit 26 is shown positioned in cap 22 and exit conduit 28 is also shown positioned in cap 22. As illustrated in FIG. 3A, injection conduit 24, air intake conduit 26, and exit conduit 28 are shown positioned in cap 22. However, injection conduit 24, air intake conduit 26, and exit conduit 28 may be positioned anywhere in chamber walls 20 or cap 22, so long as access is provided into and out of reaction chamber 18.

In some embodiments, the reaction chamber is heated to a desired temperature, such as in an oil bath, or by other suitable means. As illustrated in FIG. 3A, heat source 30 is shown underneath reaction chamber 18. In some embodiments, the heat source is an oil bath, where the reaction medium is heated by raising the temperature of the oil bath. In some embodiments, the reaction medium has a temperature of about 80-200° C., or any temperature or range of temperatures therein. In some embodiments, the reaction medium is raised to a temperature of 80-90° C., 80-100° C., 80-110° C., 80-120° C., 80-130° C., 80-140° C., 80-150° C., 80-160° C., 80-170° C., 80-180° C., 80-190° C., 80-200° C., 90-100° C., 90-110° C., 90-120° C., 90-130° C., 90-140° C., 90-150° C., 90-160° C., 90-170° C., 90-180° C., 90-190° C., 90-200° C., 100-110° C., 100-120° C., 100-130° C., 100-140° C., 100-150° C., 100-160° C., 100-170° C., 100-180° C., 100-190° C., 100-200° C., 110-120° C., 110-130° C., 110-140° C., 110-150° C., 110-160° C., 110-170° C., 110-180° C., 110-190° C., 110-200° C., 120-130° C., 120-140° C., 120-150° C., 120-160° C., 120-170° C., 120-180° C., 120-190° C., 120-200° C., 130-140° C., 130-150° C., 130-160° C., 130-170° C., 130-180° C., 130-190° C., 130-200° C., 140-150° C., 140-160° C., 140-170° C., 140-180° C., 140-190° C., 140-200° C., 150-160° C., 150-170° C., 150-180° C., 150-190° C., 150-200° C., 160-170° C., 160-180° C., 160-190° C., 160-200° C., 170-180° C., 170-190° C., 170-200° C., 180-190° C., 180-200° C., or 190-200° C. In some embodiments, the reaction medium is raised to a temperature of about 80° C.

In some embodiments of the systems and methods described herein, the system further comprises a container for collecting ammonia (NH₃) produced by the system, where the container comprises an absorbing solution. In some embodiments, the absorbing solution comprises H₂SO₄. In some embodiments, the absorbing solution comprises H₃PO₄. In some embodiments, the absorbing solution comprises a mixture of H₂SO₄ and H₃PO₄. With reference again to FIG. 3A, MFAEL 10 is fluidly connected to container 32 comprising absorbing solution 34. Container 32 is shown in fluid connection with reaction chamber 18 via exit conduit 28, whereby ammonia (NH₃) produced in reaction chamber 18 flows into container 32 and absorbing solution 34.

The systems and methods of the present disclosure are able to achieve high NH₃ production rates. In some embodiments, the systems and methods of the present disclosure achieve NH₃ production rates of at least 80 mmol h⁻¹, at least 81 mmol h⁻¹, 82 mmol h⁻¹, 83 mmol h⁻¹, 84 mmol h⁻¹, 85 mmol h⁻¹, 86 mmol h⁻¹, 87 mmol h⁻¹, 88 mmol h⁻¹, 89 mmol h⁻¹, 90 mmol h⁻¹, 91 mmol h⁻¹, 92 mmol h⁻¹, 93 mmol h⁻¹, 94 mmol h⁻¹, 95 mmol h⁻¹, 96 mmol h⁻¹, 97 mmol h⁻¹, 98 mmol h⁻¹, 99 mmol h⁻¹, 100 mmol h⁻¹, or more.

The above disclosure is general. A more specific description is provided below in the following examples. The examples are described solely for the purpose of illustration and are not intended to limit the scope of the present application. Changes in the form and substitution of equivalents are contemplated as circumstances suggest or render expedient. Although specific terms have been employed herein, such terms are intended in a descriptive sense and not for the purposes of limitation.

### EXAMPLES

The following examples are provided to illustrate embodiments of the present application but are by no means intended to limit scope.

### Example 1—An Integrated Sustainable Process for Economically Upcycling Waste Nitrogen Enabled by Low-Concentration Nitrate Electrodialysis and High-Performance Ammonia Electrosynthesis

### Materials and Methods

### Chemicals

All chemicals were used as received without purification. Nickel wire mesh (200 mesh, 0.002″ wire diameter) was purchased from Wire Mesh Store. Nickel foam (1.6 mm thickness, 99.9%) was purchased from MTI Corporation. Copper wire mesh (200 mesh, 0.002″ wire diameter) was purchased from TWP Inc. Nickel wire (0.04″ diameter, 99.5%) and nickel rod (0.12″ diameter, 99%) were purchased from Alfa Aesar. Copper wire (0.04″ diameter, 99.9%) was purchased from McMaster-Carr. Sodium hydroxide (NaOH, ≥98%), potassium hydroxide (KOH, ≥85%), sodium salicylate (≥99.5%), sodium nitroferricyanide dihydrate (Na₂[Fe(CN)₅NO].2H₂O, ≥99%), sodium hypochlorite solution (NaOCl, available chlorine 4.00-4.99%), ammonium-¹⁵N chloride (¹⁵H₄Cl, ≥98 at. % ¹⁵N), 3-(Trimethylsilyl)-1-propanesulfonic acid sodium salt (DSS, 97%), and the chemicals for the screening tests (FIG. 4B) were purchased from Sigma-Aldrich. Dimethyl sulfoxide-D6 (DMSO-d₆, D, 99.9%) was purchased from Cambridge Isotope Laboratories, Inc. Potassium nitrate (KNO₃, 99.7%), sulfuric acid (H₂SO₄, TraceMetal™ Grade), nitric acid (HNO₃, TraceMetal™ Grade), ammonium hydroxide (NH₃.H₂O, 28.0-30.0 w/w %), methanol (HPLC grade), and phosphoric acid (85%) were purchased from Fisher Chemical. Potassium nitrite (KNO₂, 97%), n-Octylamine (99+%), and deuterium oxide (D₂O, 99.8 at. % D) were purchased from Acros Organics. Protein powder (Orgain) was purchased from Amazon. Dry algae powder was kindly provided by Gross-Wen Technologies. Ammonia standard solution (100 mg L⁻¹ as NH₃—N) was purchased from Hach. Plain carbon cloth (1071 HCB) and carbon paper (Sigracet 22 BB) were purchased from Fuel Cell Store. A201 anion exchange membrane (28 μm thickness) and AS-4 ionomer solution (5 wt. %) were purchased from Tokuyama Corporation. 40% Pt on Vulcan XC-72 (Pt/C) and 40% Pt-Ir (1:1 atomic ratio) on Vulcan XC-72 (PtIr/C) were purchased from Premetek. Nitrogen (N₂, Ultra High Purity, 99.999%), argon (Ar, Ultra High Purity, 99.999%), oxygen (O₂, Ultra High Purity, 99.999%), air (Industrial Grade), and carbon dioxide (CO₂, industrial grade) were purchased from Airgas. H₂ calibration gases (10 ppm, 100 ppm, 1,000 ppm, 5,000 ppm, 10,000 ppm, balance helium) were purchased from Cal Gas Direct. N₂ calibration gases (100 ppm, 1,000 ppm, 10,000 ppm, 100,000 ppm, balance helium) were purchased from Shop Cross. Deionized (DI) water (18.2 MSΩ cm, Barnstead™ E-Pure™) was used for all experiments in this work.

### Electrochemical Measurements for NH₃ Production

### Operation of the Membrane-Free Alkaline Electrolyzer (MFAEL)

The configuration of MFAEL was modified from previous work (Chen et al., Nat. Catal. 3:1055-1061 (2020), which is hereby incorporated by reference in its entirety). In brief, the cell body (also referred to herein as “reaction chamber”), included a 100 mL screw-cap polytetrafluoroethylene (PTFE) bottle (height: 88 mm; diameter: 52 mm) and a custom-made stainless-steel lid. Two pieces of ¼″ OD alumina ceramic tubes were used for the carrier gas inlet and outlet. A union tee with a septum was connected to the gas inlet tube and offered a liquid injection port, through which water or sample solution can be supplied during cell operation. Two 10 cm² nickel mesh electrodes (3.3×3 cm², 200 mesh) were used as the electrodes, and were attached to nickel wires (0.04″ diameter) connected to a potentialstat (WaveDriver 20, for I≤1000 mA) or a DC power supply (BK Precision 1697B, for I>1000 mA). Silicone O-rings and aluminosilicate adhesive (Resbond 907GF) were used to seal the gaps and ensure the cell installation is leak-free.

Prior to the electrolysis, the NaOH/KOH/H₂O electrolyte (containing equimolar of NaOH and KOH and 40 wt. % of water) was prepared by adding 29.7 g of NaOH, 48.1 g of KOH, and 38.9 g of deionized water in the PTFE bottle, which was then sealed in an oven at 80° C. overnight for the complete dissolution of NaOH and KOH. For typical tests, an appropriate amount of N-containing reactant was added before the cell cap was installed. For electrochemical NO₃⁻ reduction (NO3RR), the amount of added KNO₃ was equal to the theoretical amount of NO₃⁻ that can be fully converted to NH₃ based on the applied charge. For the conversion of organic Nr compounds, the amount of added reactant was specified in the figure captions. Subsequently, the cell was placed in an oil bath preheated to 80° C., and 200 mL min⁻¹ of N₂ was bubbled from the gas inlet tube into the electrolyte. The outlet gas from MFAEL was bubbled into an acidic absorbing solution (100 mL of 0.1 M H₂SO₄) for NH₃ collection.

After 30 min of gas bubbling to remove the air from the system, a constant current was applied between the electrodes. During electrolysis, the absorbing solution was changed every 30 min for NH₄⁺ quantification. After electrolysis, the system was kept with gas bubbling for additional 30 min to deplete the remaining NH₃ in the gas line. The electrolyte was then carefully diluted to 1 L with deionized water for the quantification of NO₃⁻, NO₂⁻, and organic products (detailed in Product Quantification section).

The conversion of NO₃⁻ (X) and faradaic efficiency of product i (FEᵢ) were calculated by

$$X = \frac{{n}_{0} - n}{{n}_{0}} \times 100 \% \\ {FE}_{i} = \frac{{n}_{i} {z}_{i} F}{Q} \times 100 \%$$

where n₀ is the initial amount of NO₃⁻ (mol); n is the amount of NO₃⁻ after electrolysis (mol); nᵢ is the amount of product i (mol); zᵢ is the number of electrons transferred to product i; F is the Faraday constant (96,485 C mol⁻¹); and Q is the total charge passed through the electrolytic cell (C).

The NH₃ production rate was calculated by

$$rate ( mol {cm}^{- 2} {s}^{- 1} ) = \frac{cV}{At}$$

where c is the NH₄⁺ concentration (M); V is the volume of the absorbing solution (L); A is the geometric area of the electrode (cm²); t is the electrolysis duration (s).

The N balance for Nr conversion was calculated by

$$N balance ( \% ) = \frac{amount of detected N species after reaction}{amount of added Nr} \times 100 \%$$

For the real N-containing samples (protein and algae powder), the content of N (wt. %) was determined by a Combustion Elemental Analyzer (CHN/S Thermo FlashSmart 2000).

### Measurement of Roughness Factor (RF)

To compare the electrochemically active surface area of the Ni-based electrodes before and after electrolysis in the NaOH/KOH/H₂O electrolyte, cyclic voltammetry (“CV”) measurements were carried out in a single-compartment cell with a standard three-electrode configuration without stirring (Morales and Risch, J. Phys. Energy, 3:034013 (2021), which is hereby incorporated by reference in its entirety). The electrolyte was 1 M KOH. The geometric area of the working electrode was 1 cm² (1×1 cm²). An Ag/AgCl electrode (saturated KCl, E⁰=0.197 V vs. SHE) and a Pt foil were used as the reference electrode and counter electrode, respectively. Different scan rates ranging from 50 to 200 mV s⁻¹ were applied.

### NO3RR in the Scaled-up MFAEL

The configuration of the scaled-up MFAEL is similar to the 100 mL reactor. The cell body included a 2.5 L screw-cap PTFE bottle (height: 260 mm; diameter: 131 mm), a custom-made stainless-steel lid, two pieces of ½″ OD alumina ceramic tubes, two 100 cm² nickel mesh electrodes (10×10 cm², 200 mesh), and two nickel rods (0.12″ diameter) for conducting electricity. The nickel rods were bent and stitched through the folded nickel mesh electrodes to ensure stable contact, and were connected to a DC power supply (BK Precision 1901B). Silicone O-rings and aluminosilicate adhesive (Resbond 907GF) were used to seal the gaps and ensure the cell installation is leak-free. The amount of electrolyte was 25 times higher than the 100 mL reactor, and the amount of added KNO₃ was equal to the theoretical amount of NO₃⁻ that can be fully converted to NH₃ based on the applied charge. The flow rate of carrier gas was 500 mL min⁻¹. The applied current was 25 A (corresponding to 250 mA cm⁻² of current density), and the electrolysis time was 24 hours.

Different absorbing solutions were used for obtaining different NH₃-based chemical products. For NH₄⁺ salts, 400 mL of 5 M H₂SO₄ was used for NH₃ absorption. For producing pure NH₃ solution, 100 mL of deionized water was used for NH₃ absorption, which was cooled with 5° C. circulated water by a chiller. It should be noted that the volume of the absorbing solution increased during electrolysis due to the condensation of water vapor and the decrease of solution density due to the increasing NH₃ content. For producing NH₄HCO₃, 100 mL of deionized water was pre-saturated with CO₂ and continuously bubbled with 500 mL min⁻¹ of CO₂ during the electrolysis. Considering the decomposition temperature of NH₄HCO₃ (36° C.), the absorbing solution was also cooled with 5° C. circulated water and magnetically stirred at 400 r.p.m. Due to the relatively low solubility of NH₄HCO₃ (around 14.3 g in 100 mL of water), solid was precipitated in the absorbing solution. After the reaction, solid NH₄HCO₃ was obtained by vacuum filtration, followed by washing with ethanol and drying at room temperature. The remaining unabsorbed NH₃ from water and CO₂-saturated water was collected by a second absorbing solution containing 400 mL of 5 M H₂SO₄.

### Direct NH₃ Fuel Cell Tests

The catalysts were deposited onto the electrode substrates by spray coating. For the preparation of the anode, a plain carbon cloth was first treated in HNO₃ (67-70%) at 110° C. for 1 h 45 min to improve its hydrophilicity. The catalyst ink was prepared by dispersing PtIr/C and AS-4 ionomer in 2-propanol (10 mg_{catalyst} mL⁻¹), with a weight ratio of 9:1 between the catalyst and dry ionomer. The ink was then spray-coated onto the hydrophilic carbon cloth. For the cathode, the catalyst ink was prepared by dispersing Pt/C and AS-4 ionomer in a 7:3 mixture of 2-propanol and water (10 mg_{catalyst} mL⁻¹), and the weight ratio between the catalyst and dry ionomer was 7:3, which was spray-coated onto a piece of carbon paper (Sigracet 22 BB). The final loading of platinum-group metal was 1.0 mg cm⁻² for both cathode and anode.

NH₃ fuel cell tests were performed with a Scribner 850e Fuel Cell Test System. The fuel cell configuration includes stainless-steel end plates, gold-coated current collectors, graphite flow-field plates with serpentine channels, PTFE and silicone gaskets, two electrodes, and an anion-exchange membrane (Tokuyama A201). The active area of the membrane-electrode assembly (MEA) was 5 cm², which was formed after assembling the cell hardware. The cell temperature was 80° C. 75 mL of the NH₃ solution obtained from MFAEL (with 1.25 M added KOH) was supplied to the anode and circulated by a peristaltic pump at a flow rate of 4 mL min⁻¹, and the reservoir of the NH₃ solution was kept at 5° C. by cooling water from a chiller. 500 mL min⁻¹ of O₂ was passed through a humidifier at 80° C. before entering the cathode flow field at atmospheric pressure.

### Product Quantification

### Quantification of NH₃

NH₃ in the absorbing solution (0.1 M H₂SO₄) was quantified by the indophenol blue colorimetric method. Four freshly prepared reagents were used, including (a) coloring solution, containing 0.4 M sodium salicylate and 0.32 M NaOH; (b) oxidizing solution, containing 0.75 M NaOH in NaClO solution; (c) catalyst solution, containing 10 mg ml⁻¹ of Na₂[Fe(CN)₅NO].2H₂O; and (d) 6 M NaOH solution. The sample solution was first diluted with 0.1 M H₂SO₄ to the proper range of NH₃ concentration. 4 mL of the diluted sample solution was then added into a glass vial, followed by the sequential addition of 200 μL of (d), 50 μL of (b), 500 μL of (a), and 50 μL of (c). The reagents were mixed by shaking vigorously and kept in a dark place for color development. After 2 h, absorbance was measured by a UV-Vis spectrophotometer (Shimadzu UV-2700) at 660 nm. The calibration curve was established by testing a series of standard NH₃ solutions ranging from 0 to 2.5 mg L⁻¹ (in NH₃—N) diluted with 0.1 M H₂SO₄.

For the ¹⁵N isotope labeling experiment, the concentrations of ¹⁴NH₃ and ¹⁵NH₃ (in 0.1 M H₂SO₄) were determined by ¹H Nuclear Magnetic Resonance (NMR) spectroscopy on an NMR spectrometer (Bruker Avance NEO 400 MHz). The sample solution was first diluted with 0.1 M H₂SO₄ to the proper range of NH₃ concentration. 800 μL of the diluted sample solution was then mixed with 200 μL of DMSO-d₆ and 200 μL of 32 μM maleic acid in DMSO-d₆ (internal standard). The scan number was 1,024 with a water suppression method. Standard ¹⁴NH₃ and ¹⁵NH₃ solutions were prepared for calibration with concentrations ranging from 0 to 5 mg L⁻¹ (in ¹⁴N and ¹⁵N). NH₃ content in CO₂-saturated water was also quantified by ¹H NMR due to the pH-sensitive nature of the colorimetric method.

Ion chromatography (IC) was also employed for NH₃ quantification to verify the accuracy. IC measurements were performed on a Dionex™ Easion system equipped with a conductivity detector, 4 mm Dionex IonPac CG12A/CS12A columns, and a CCRS 500 suppressor. The mobile phase was 20 mM methanesulfonic acid, and was pumped at a flow rate of 1.0 mL min⁻¹. The running time was 8 min. The calibration solutions were prepared with (NH₄)₂SO₄ in the concentration range of 20-100 mg L⁻¹ (in NH₃—N).

### Quantification of NO₃⁻ and NO₂⁻

NO₃⁻ and NO₂⁻ in the diluted electrolyte were analyzed by High-Performance Liquid Chromatography (HPLC) (Chou et al., J. Food Drug Anal. 11:233-238 (2003), which is hereby incorporated by reference in its entirety) (Agilent Technologies, 260 Infinity II LC System) equipped with a variable wavelength detector (Agilent 1260 Infinity Variable Wavelength Detector VL). The wavelength of 213 nm was chosen for NO₃⁻ detection. A C18 HPLC column (Gemini® 3 μm, 110 Å, 100×3 mm) was used for analysis at 25° C. with a binary gradient pumping method to drive the mobile phase at 0.4 mL min⁻¹. The mobile phase included 0.01 M n-Octylamine in a mixed solution containing 30 vol. % methanol and 70 vol. % deionized water, and the pH of the mobile phase was adjusted to 7.0 with phosphoric acid. The running time was 30 min. The calibration solutions for NO₃⁻ or NO₂⁻ were prepared with KNO₃ or KNO₂ in the concentration range of 0.0625-2 mM.

### Identification and Quantification of Organic Products

To identify the products from the oxidation of C—N bonds, ¹³C-labeled glycine and alanine were used as simple organic Nr compounds as the reactants in MFAEL, and the products were analyzed by ¹³C NMR on an NMR spectrometer (Bruker Avance NEO 400 MHz). 1 mL of the sample solution (diluted electrolyte) was mixed with 200 μL of D₂O and 200 μL of 50 mg mL⁻¹ DSS solution (internal standard). The scan number was 128.

To quantify the reactant (alanine) and product (acetate) after electrolysis, 1H NMR was carried out on a Bruker AVIII-600 MHz NMR spectrometer. 400 μL of the sample solution (diluted electrolyte) was mixed with 200 μL of D2O and 100 μL of 15 mM dimethylmalonic acid (DMMA) solution (internal standard). The scan number was 8. The calibration solutions for alanine and acetate were prepared in the concentration range of 0-20 mM.

The carboxylic acid products were also identified and quantified by HPLC. The wavelength of 220 nm was selected. An OA-1000 organic acids column (Grace®, length: 300 mm, ID: 6.5 mm, part no. 9046) was used for analysis at 25° C. with a binary gradient pumping method to drive the mobile phase (5 mM sulfuric acid) at 0.6 mL min⁻¹. The running time was 30 min. Solutions prepared by a series of standard chemicals were also tested by ¹³C NMR and HPLC for product identification, including carbonate, formate, glycolate, glyoxylate, oxamate, oxalate, lactate, pyruvate, acetate, and acrylate.

### Quantification of Gaseous Products

The gaseous products of NO3RR in the NaOH/KOH/H₂O electrolyte were analyzed by online gas chromatography (SRI Instruments, 8610C, Multiple Gas #3) equipped with HayeSep D and Mol Sieve 5 Å columns and a thermal conductivity detector. The MFAEL was operated under the same conditions specified below, except that Ar was used as the carrier gas at a lower total flow rate of 85 mL min⁻¹. During the measurement, an 8-min programmed cycle was repeated, including 6 min of the GC running period and 2 min of the cooling period.

For each cycle, the generation of product i (nᵢ, mol) was calculated by

$${n}_{i} = {c}_{i} \times {10}^{- 6} \times \frac{p \dot{V} \times {10}^{- 6} \times t}{RT}$$

where cᵢ is the concentration (ppmv) of product i; \dot{V} is the volumetric flow rate of the gas (mL min⁻¹); p is the atmospheric pressure (p=1.013×10⁵ Pa); R is the gas constant (R=8.314 J mol⁻¹ K⁻¹); T is the room temperature (293.15 K); t is the running time of each cycle (min). The calibration curves of H₂ (10-10,000 ppm) and N₂ (100-100,000 ppm) were established by analyzing the standard calibration gases.

### Physical Characterization

X-Ray Diffraction (XRD) crystallography was carried out on a Rigaku Smartlab high-resolution X-ray diffractometer with Cu K-alpha radiation (wavelength, λ=1.5406 Å) and a tube voltage of 40 kV (with a tube current of 30 mA). The scan was performed at a rate of 10° min⁻¹ and a step size of 0.01°. Scanning electron microscopy (SEM) imaging and Energy Dispersive X-ray Spectroscopy (EDS) were performed on a FEI Quanta-250 field-emission scanning electron microscope with a light-element X-ray detector and an Oxford Aztec energy-dispersive X-ray analysis system. X-ray Photoelectron Spectroscopy (XPS) was performed on a Kratos Amicus/ESCA 3400 X-ray photoelectron spectrometer with Mg K-alpha X-ray (1,253.7 eV), and all spectra were calibrated with the C 1s peak at 284.8 eV. Raman spectra were collected using an inVia 488 nm Renishaw Coherent Laser Raman Spectrometer calibrated to an internal standard silicon reference centered at 520.5±0.5 cm−1. Samples were tested under a 20× objective lens, with a spot size of ˜2500 μm2, from 100-4000 cm−1 with 10 accumulations at 12.5 mW power.

### Results and Discussion

### High-Rate NH₃ Production by NO₃⁻ Reduction (NO3RR) in NaOH/KOH/H₂O

With ultrahigh alkalinity, the “NaOH/KOH/H₂O” electrolyte was first introduced in an attempt to convert N₂ to NH₃, but the system was later confirmed to completely reduce NOₓ⁻—N even at a trace amount to NH₃ on simple metal electrodes (Licht et al., Science 345:637-640 (2014); Licht et al., Science 369:780 (2020), Chen et al., Nat. Catal. 3:1055-1061 (2020); which are hereby incorporated by reference in their entirety). Such an unexpected finding implies that this strongly alkaline electrolyte holds the potential of efficiently converting Nr into NH₃ for the alternative upcycling of waste nitrogen.

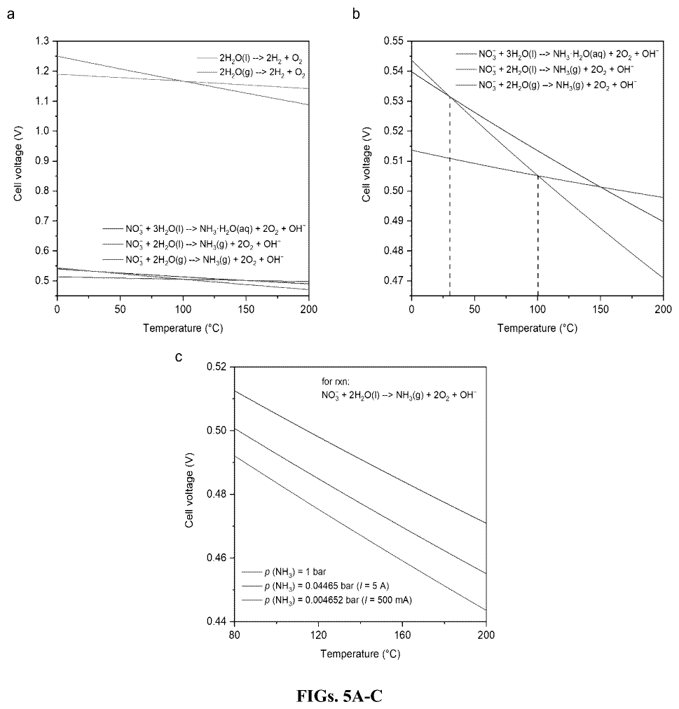

Thermodynamic analysis performed in this work (FIGS. 5A-C) clearly indicates that the reduction of NO₃⁻ to NH₃ is much more favorable than the reduction of water (i.e., the hydrogen evolution reaction, HER). Further, formation of gaseous NH₃ is even more favorable than that of aqueous NH₃ (NH₃.H₂O) at temperatures greater than 30° C. In addition, if the produced NH₃ can be removed timely from the reaction system (such as by a carrier gas flow), the thermodynamic cell voltage will be further reduced due to the shift in the chemical equilibrium.

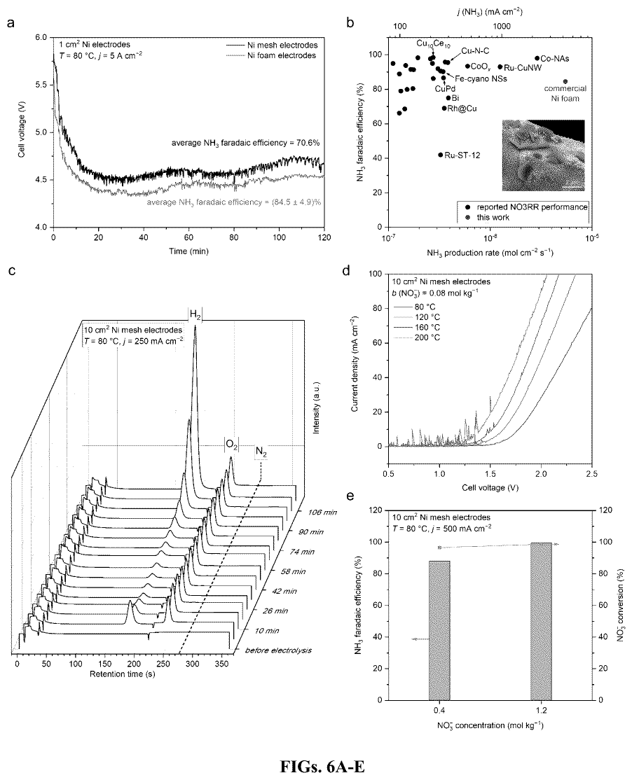

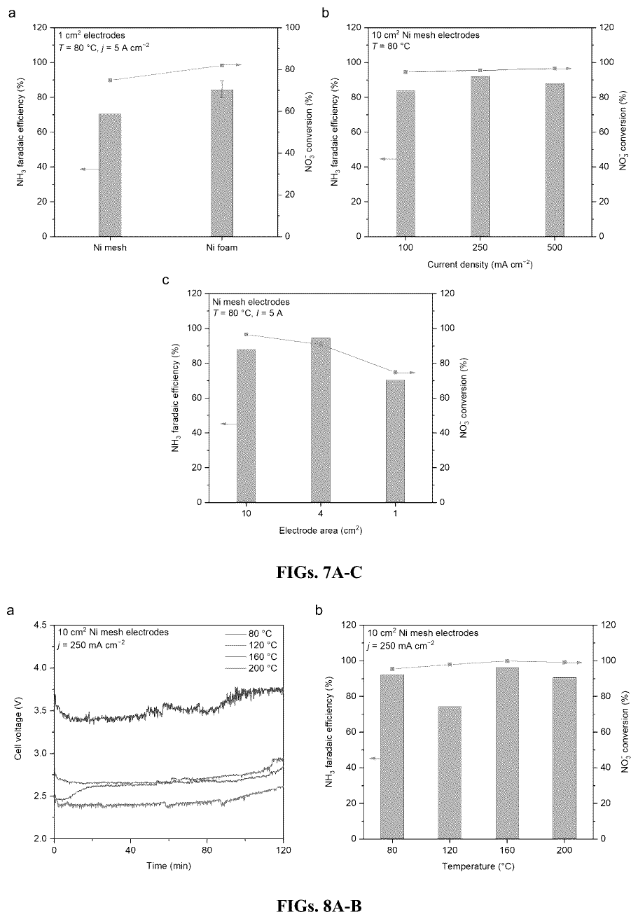

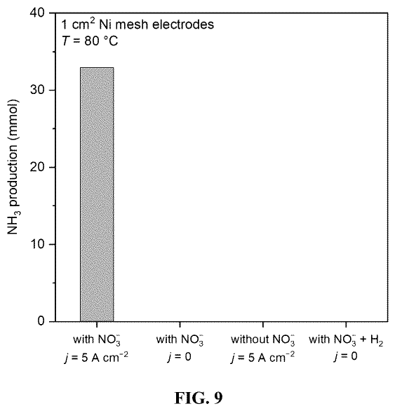

Motivated by these results, the Nr-to-NH₃ conversion in the NaOH/KOH/H₂O electrolyte on simple nickel (mesh and foam) electrodes at a range of elevated temperature of 80-200° C. in a one-compartment MFAEL system was investigated (FIGS. 3A-B). In the NaOH/KOH/H₂O electrolyte with a carefully-chosen composition (containing equimolar of NaOH and KOH with 40 wt. % of water), the NO₃⁻-to-NH₃ conversion on simple Ni cathodes is surprisingly active: an NH₃ partial current density of 4.22±0.25 A cm⁻² was obtained with 84.5±4.9% of FE towards NH₃ and 82.0±0.2% of NO₃⁻ conversion on a commercial nickel foam at 80° C. (FIG. 6A and 7A). Such an NH₃ partial current density is the highest performance based on geometric electrode area by far in the field to what is currently known (FIG. 6B and Table 1). Despite the slightly lower faradaic efficiency, this record-high NH₃ partial current density on the simple Ni foam is roughly double that on the Co—NAs (2.23 A cm⁻²) (Deng et al., Adv. Sci. 8:2004523 (2021), which is hereby incorporated by reference in its entirety) and quadruple that on the Ru-CuNW (0.965 A cm⁻²) (Chen et al., Nat. Nanotechnol. 17:759-767 (2022), which is hereby incorporated by reference in its entirety). At lower current densities, the NO₃⁻ conversion can be improved to 94.5%-96.5% at 100-500 mA cm⁻², while maintaining a high level of FE for NH₃ (84.0%-92.2%) (FIG. 7B). Furthermore, the MFAEL system can function efficiently at temperatures up to 200° C. without considerable decrease in the FE towards NH₃ or NO₃⁻ conversion (FIG. 6D and FIGS. 8A-B). Notably, raising the initial NO₃⁻ concentration can further enhance the FE towards NH₃ to 99.5% at 500 mA cm⁻², while the NO₃⁻ conversion remained high (98.8%) (FIG. 6E).

TABLE 1
Summary of state-of-the-art reported performances of NO3RR for electrochemical
NH₃ production (sorted by the geometric area-normalized NH₃ production rate).

| | | | NH₃ production rate | j(NH₃) | FE | Potential | Cell |
|---|---|---|---|---|---|---|---|
| Ref. | Catalyst | Electrolyte | (mol cm⁻² s⁻¹) | (mA cm⁻²) | (%) | (V_{RHE}) | configuration |
| this work | commercial Ni foam | NaOH/KOH/H₂O | 5.47 × 10⁻⁶ | 4,220 | 84.5 | 4.48 (full cell) | undivided cell |
| | commercial Ni foam | (40 wt. % H₂O) | 5.87 × 10⁻⁷ | 453 | 90.6 | 3.43 (full cell) | |
| | commercial Ni mesh | | 1.09 × 10⁻⁷ | 84.0 | 84.0 | 2.56 (full cell) | |
| ¹ | Co—NAs | 1M KOH | 2.89 × 10⁻⁶ | 2,230 | 98 | −0.24 | H-cell |
| ² | Ru—CuNW | 1M KOH | 1.25 × 10⁻⁶ | 965 | 93 | −0.135 | H-cell |
| ³ | CoOₓ nanosheets | 0.1M KOH | 5.98 × 10⁻⁷ | 462 | 93.4 | −0.3 | H-cell |
| ⁴ | Bi | 1M KOH | 3.88 × 10⁻⁷ | 299 | 75 | −0.8 | H-cell |
| ⁵ | Cu—N—C | 1M KOH | 3.83 × 10⁻⁷ | 296 | 95.5 | −1 | H-cell |
| ⁶ | Cu-NBs-100 | 1M KOH | 3.61 × 10⁻⁷ | 279 | 95.8 | −0.15 | H-cell |
| ⁷ | Rh@Cu | 0.1M Na₂SO₄ (pH 11.5) | 3.53 × 10⁻⁷ | 272 | 69 | −0.4 | H-cell |
| ⁸ | CuPd | 1M KOH | 3.47 × 10⁻⁷ | 268 | 86.6 | −0.6 | H-cell |
| ⁹ | Fe-cyano NSs | 1M KOH | 3.44 × 10⁻⁷ | 265 | 90.2 | −0.5 | H-cell |
| ¹⁰ | Ru-ST-12 | 1M KOH | 3.25 × 10⁻⁷ | 251 | 42 | −0.8 | H-cell |
| ¹¹ | CuCoSP | 0.1M KOH | 3.25 × 10⁻⁷ | 251 | 90.6 | −0.175 | H-cell |
| ¹² | OD-Cu | 1M KOH | 3.06 × 10⁻⁷ | 236 | 92 | −0.15 | H-cell |
| ¹³ | CoP NAs | 1M NaOH | 2.76 × 10⁻⁷ | 213 | 86.2 | −0.3 | undivided cell |
| ¹⁴ | Cu₁₀Ce₁₀ | 1M KOH | 2.75 × 10⁻⁷ | 212 | 98.43 | −0.23 | H-cell |
| ¹⁵ | NiCo₂O₄/CC | 0.1M NaOH | 2.70 × 10⁻⁷ | 209 | 95 | −0.6 | H-cell |
| ¹⁶ | CoFe LDH | 1M KOH | 2.58 × 10⁻⁷ | 199 | 97.68 | −0.45 | H-cell |
| ¹⁷ | island-like Cu | 0.5M Na₂SO₄ | 1.94 × 10⁻⁷ | 150 | 98.28 | −0.8 | H-cell |
| ¹⁸ | ZnCo₂O₄ | 0.1M NaOH | 1.76 × 10⁻⁷ | 136 | 91.4 | −0.8 | H-cell |
| ¹⁹ | TiO₂ | 1M PBS | 1.74 × 10⁻⁷ | 134 | 80.4 | −1.25 | H-cell |
| ²⁰ | Fe₃O₄/SS | 0.1M NaOH | 1.66 × 10⁻⁷ | 128 | 91.5 | −0.5 | H-cell |
| ²¹ | Pd(111) | 0.1M Na₂SO₄ | 1.52 × 10⁻⁷ | 118 | 79.91 | −0.7 | H-cell |
| ²² | CoO@NCNT/GP | 0.1M NaOH | 1.48 × 10⁻⁷ | 114 | 93.8 | −0.6 | H-cell |
| ²³ | pCuO-5 | 0.05M H₂SO₄ | 1.44 × 10⁻⁷ | 111 | 68.6 | 2.2 (full cell) | flow cell |
| ²⁴ | Fe₃C/NC | 1M KOH | 1.32 × 10⁻⁷ | 102 | 79 | −0.5 | H-cell |
| ²⁵ | BCN@Cu | 0.1M KOH | 1.28 × 10⁻⁷ | 98.8 | 88.9 | −0.6 | H-cell |
| ²⁶ | Fe SAC | 0.1M K₂SO₄ | 1.28 × 10⁻⁷ | 98.6 | 66.2 | −0.85 | H-cell |
| ²⁷ | Cu₅₀Ni₅₀/Cu foam | 1M KOH | 1.11 × 10⁻⁷ | 85.5 | 95 | −0.1 | flow cell |

Table 1 References:
¹ Deng et al., Adv. Sci. 8: 2004523 (2021)
² Chen et al., Nat. Nanotechnol. DOI: 10.1038/s41565-022-01121-4 (2021)
³ Wang et al., ACS Catal. 11: 15135-15140 (2021)
⁴ Zhang et al., ACS Nano 16: 4795-4804 (2022)
⁵ Xu et al., ChemSusChem 15: e202200231 (2022)
⁶ Hu et al., Energy Environ. Sci. 14: 4989-4997 (2021)
⁷ Liu et al., Angew. Chem. Int. Ed. 61: e202202556 (2022)
⁸ Gao et al., Nat. Commun. 13: 2338 (2022)
⁹ Fang et al., ACS Nano 16: 1072-1081 (2022)
¹⁰ Li et al., J. Am. Chem. Soc. 142: 7036-7046 (2020)
¹¹ He et al., Nat. Commun. 13: 1129 (2022)
¹² Yuan et al., ACS Appl. Mater. Interfaces 13: 52469-52478 (2021)
¹³ Ye et al., Energy Environ. Sci. 15: 760-770 (2022)
¹⁴ Yang et al., Electrochim. Acta 411: 140095 (2022)
¹⁵ Liu et al., Small 18: 2106961 (2022)
¹⁶ Du et al., Chem. Eng. J. 434: 134641 (2022)
¹⁷ Wang et al., ACS Appl. Mater. Interfaces 14: 6680-6688 (2022)
¹⁸ Li et al., Mater. Today Phys. 23: 100619 (2022)
¹⁹ Xu et al., ChemSusChem 15: e202102450 (2022)
²⁰ Fan et al., Nano Res. 15: 3050-3055 (2022)
²¹ Han et al., J. Colloid Interface Sci. 600: 620-628 (2021)
²² Chen et al., Chem. Commun. 58: 5901-5904 (2022)
²³ Daiyan et al., Energy Environ. Sci. 14: 3588-3598 (2021)
²⁴ Wang et al., Green Chem. 23: 7594-7608 (2021)
²⁵ Zhao et al., J. Mater. Chem. A 9: 23675-23686 (2021)
²⁶ Wu et al., Nat. Commun. 12: 2870 (2021)
²⁷ Wang et al., J. Am. Chem. Soc. 142: 5702-5708 (2020)

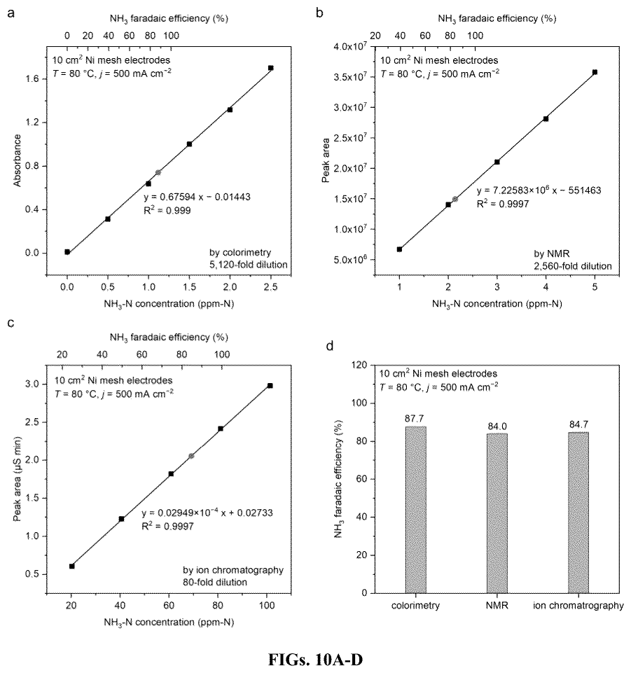

A series of control experiments performed in this study (FIG. 9) confirms that the observed NH₃ production is indeed from the electro-reduction of NO₃⁻, without considerable interference from the contamination of other Nr (other than NO₃⁻), non-faradaic reactions between the electrode and NO₃⁻, or the reaction between NO₃⁻ and H₂. Accuracy of NH₃ quantification was cross-verified by comparing the results obtained from indophenol colorimetry (adopted method in this work) with ¹H NMR and ion chromatography, and the difference in their results was <5% (FIGS. 10A-D).

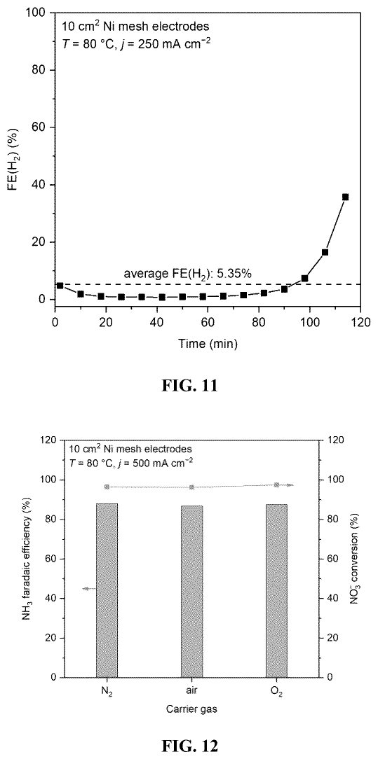

Online gas chromatography (GC) also confirmed that HER is largely suppressed with a very low level of FE (e.g., an average FE of 5.35% at 250 mA cm⁻²), and N₂ generation was not detected during the entire course of electrolysis (FIG. 6C and FIG. 11). These results are in concert with the close-to-unity balance of N element (considering NO₃⁻, NO₂⁻, and NH₃) for all measurements (Table 2), showing that NH₃ is the exclusive favorable product of NO3RR in the NaOH/KOH/H₂O electrolyte. Note that the observed FE towards NO₂⁻ was lower than 6% for all measurements, indicating the facile sequential reduction of N—O bonds towards the fully hydrogenated product NH₃.

TABLE 2
Summary of the results of constant-current NO3RR tests in the NaOH/KOH/H₂O electrolyte in this work.

| | | | | | | | | Elec- | | | | | | | |
|---|---|---|---|---|---|---|---|---|---|---|---|---|---|---|---|
| | | | | | | | | trol- | | NH₃ | | | | | |
| | Added | Water | | | | Electrode | j | ysis | Average | produc- | NO₃⁻ | NO₂⁻ | NH₃ | X | N |
| | NO₃⁻ | content | T | | | area | (mA | time | V_{cell} | tion | after rxn | FE | FE | (NO₃⁻) | balance |
| Entry | (mmol) | (%) | (° C.) | Cathode | Anode | (cm²) | cm⁻²) | (h) | (V) | (mmol) | (mmol) | (%) | (%) | (%) | (%) |
| 1 | 9.33 | 40 | 80 | Ni mesh | Ni mesh | 10 | 100 | 2 | 2.56 | 7.832 | 0.514 | 2.33 | 84.0 | 94.5 | 98.7 |
| 2 | 23.32 | 40 | 80 | Ni mesh | Ni mesh | 10 | 250 | 2 | 3.53 | 21.49 | 1.052 | 1.90 | 92.2 | 95.5 | 104.3 |
| 3 | 46.64 | 40 | 80 | Ni mesh | Ni mesh | 10 | 500 | 2 | 3.93 | 41.08 | 1.611 | 2.03 | 88.1 | 96.5 | 99.6 |
| 4 | 139.92 | 40 | 80 | Ni mesh | Ni mesh | 10 | 500 | 6 | 4.01 | 139.21 | 1.720 | 0.35 | 99.5 | 95.3 | 101.0 |
| 5 | 23.32 | 40 | 120 | Ni mesh | Ni mesh | 10 | 250 | 2 | 2.71 | 17.36 | 0.483 | 5.18 | 74.4 | 97.9 | 97.2 |
| 6 | 23.32 | 40 | 160 | Ni mesh | Ni mesh | 10 | 250 | 2 | 2.65 | 22.45 | 0.014 | 1.05 | 96.3 | 99.9 | 100.5 |
| 7 | 9.33 | 40 | 200 | Ni mesh | Ni mesh | 10 | 100 | 2 | 2.08 | 7.927 | 0.090 | 1.09 | 85.0 | 99.0 | 90.3 |
| 8 | 23.32 | 40 | 200 | Ni mesh | Ni mesh | 10 | 250 | 2 | 2.44 | 21.13 | 0.205 | 0.79 | 90.6 | 99.1 | 94.7 |
| 9 | 46.64 | 40 | 200 | Ni mesh | Ni mesh | 10 | 500 | 2 | 3.49 | 40.13 | 0.060 | 0.49 | 86.0 | 99.9 | 88.1 |
| 10 | 9.33 | 91 | 80 | Ni mesh | Ni mesh | 10 | 100 | 2 | 2.87 | 4.705 | 3.619 | 1.67 | 50.4 | 61.2 | 95.9 |
| 11 | 9.33 | 99 | 80 | Ni mesh | Ni mesh | 10 | 100 | 2 | 4.13 | 3.775 | 4.476 | 1.55 | 40.5 | 52.0 | 94.6 |
| 12 | 46.64 | 40 | 80 | Ni mesh | Ni mesh | 4 | 1,250 | 2 | 4.28 | 44.07 | 4.302 | 1.79 | 94.5 | 90.8 | 110.9 |
| 13 | 46.64 | 40 | 80 | Ni mesh | Ni mesh | 1 | 5,000 | 2 | 4.64 | 32.91 | 11.74 | 1.39 | 70.6 | 74.8 | 101.3 |
| 14 | 46.64 | 40 | 80 | Ni mesh | Ni foam | 10 | 500 | 2 | 3.47 | 40.82 | 2.578 | 2.75 | 87.5 | 94.5 | 104.0 |
| 15 | 46.64 | 40 | 80 | Ni foam | Ni foam | 10 | 500 | 2 | 3.43 | 42.26 | 1.175 | 2.76 | 90.6 | 97.5 | 104.2 |
| 16 | 46.64 | 40 | 80 | Ni foam | Ni mesh | 1 | 5,000 | 2 | 4.42 | 35.41 | 8.520 | 1.78 | 75.9 | 81.7 | 101.3 |
| 17 | 46.64 | 40 | 80 | Ni foam | Ni foam | 1 | 5,000 | 2 | 4.48 | 40.63 | 8.301 | 1.61 | 87.1 | 82.2 | 111.3 |
| 18 | 46.64 | 40 | 80 | Ni foam | Ni foam | 1 | 5,000 | 2 | 4.63 | 40.85 | 8.485 | 2.17 | 87.6 | 81.8 | 114.4 |
| 19 | 46.64 | 40 | 80 | Ni foam | Ni foam | 1 | 5,000 | 2 | 4.73 | 36.75 | 8.463 | 2.23 | 78.8 | 81.9 | 105.6 |
| 20 | 46.64 | 40 | 80 | Ni foam | graphite | 1 (cathode) | 5,000 | 2 | 5.85 | 33.31 | 6.345 | 2.46 | 71.4 | 86.4 | 94.8 |
| | | | | | rod | 8.9 (anode) | | | | | | | | | |
| 21 | 46.64 | 40 | 80 | Cu mesh | Ni mesh | 1 | 5,000 | 2 | 4.86 | 28.58 | 12.85 | 1.16 | 61.3 | 72.4 | 93.5 |
| 22[a] | 46.64 | 40 | 80 | Ni mesh | Ni mesh | 10 | 500 | 2 | 4.05 | 40.47 | 1.741 | 2.22 | 86.8 | 91.1 | 99.4 |
| 23[a] | 46.64 | 40 | 80 | Ni mesh | Ni mesh | 10 | 500 | 2 | 3.63 | 40.85 | 1.151 | 1.74 | 87.6 | 97.5 | 97.0 |
| 24 | 9.33 | 40 | 80 | Ru foil | graphite | 1 (cathode) | 1,000 | 2 | 3.47 | 3.218 | 5.700 | 0.19 | 34.5 | 38.9 | 99.4 |
| | | | | | rod | 8.9 (anode) | | | | | | | | | |
| 25 | 9.33 | 40 | 80 | Cu foil | graphite | 1 (cathode) | 1,000 | 2 | 3.83 | 2.920 | 5.939 | 0.12 | 31.3 | 36.3 | 97.4 |
| | | | | | rod | 8.9 (anode) | | | | | | | | | |
| 26 | 9.33 | 40 | 80 | Co foil | graphite | 1 (cathode) | 1,000 | 2 | 3.35 | 3.610 | 5.613 | 0.13 | 38.7 | 39.8 | 101.4 |
| | | | | | rod | 8.9 (anode) | | | | | | | | | |
| 27 | 9.33 | 40 | 80 | Ni foil | graphite | 1 (cathode) | 1,000 | 2 | 3.43 | 3.066 | 5.968 | 0.12 | 32.9 | 36.0 | 99.2 |
| | | | | | rod | 8.9 (anode) | | | | | | | | | |

[a]For Entry 22 and 23, air and O₂ was used as the carrier gas, respectively. Air was pre-scrubbed in 0.1M KOH before entering the MFAEL.

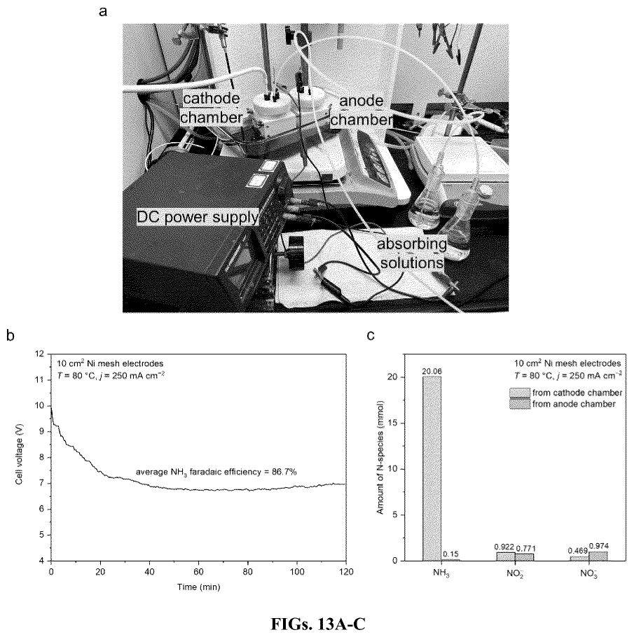

Interestingly, replacing the carrier gas (high-purityN₂) with air or high-purity O₂ does not induce any considerable change in the cell performance (FIG. 12), demonstrating the robustness of the MFAEL system, as inexpensive air can be used to realize efficient product separation without interference from the O₂ content. Separating the catholyte and anolyte with a porous PTFE mesh resulted in a similarly high FE (86.7%, FIGS. 13A-C), which strongly suggests that the co-generated H₂ and O₂ have minimal impact on the performance of NO3RR.

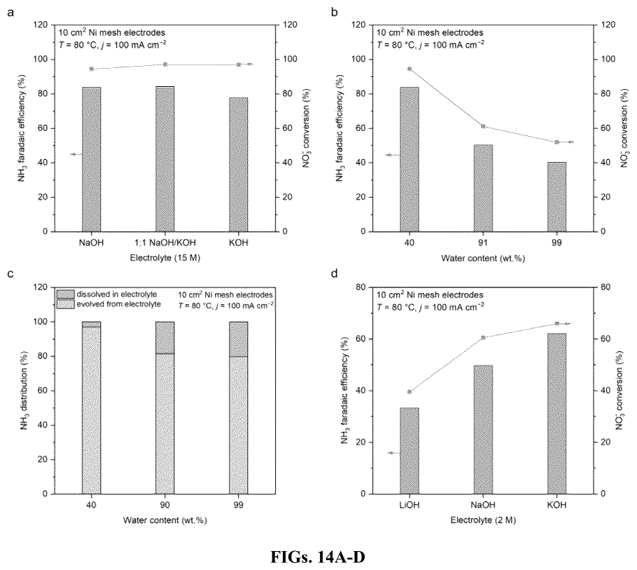

High alkalinity of NaOH/KOH/H₂O electrolyte is needed for the high-efficiency NO₃⁻-to-NH₃ conversion in MFAEL. 1:1 molar NaOH/KOH was chosen to constitute the best composition of ternary NaOH/KOH/H₂O electrolyte due to the optimal performance and the maximum window for tuning water content, compared to the binary NaOH/H₂O or KOH/H₂O electrolyte (FIG. 14A) (Janz et al., Physical Properties Data Compilations Relevant to Energy Storage. II. Molten Salts: Data on Single and Multi-Component Salt Systems, U .S. Government Printing Office, Washington (1979), which is hereby incorporated by reference in its entirety). Increasing the water content of the electrolyte from 40 wt. % to 91 and 99 wt. % (40, 91, and 99 wt. % of water content correspond to 15, 2, and 0.2 M of OH⁻ concentration, respectively) leads to a significant decrease in the FE towards NH₃ and the NO₃⁻ conversion (FIG. 14B). In addition, higher alkalinity facilitates the evolution of produced NH₃ from the MFAEL reactor, as observed from the distribution of NH₃ after electrolysis (FIG. 14B). These tendencies agree with the thermodynamic calculation results in FIG. 5. The type of chosen alkali for the electrolyte has modest effect on the NO3RR performance at high alkalinity (15 M OH⁻, FIG. 14A); with 2 M OH⁻ an apparent cationic effect was observed, and FE towards NH₃ shows the discernible trend of Li⁺<Na⁺<K⁻ (FIG. 14D).

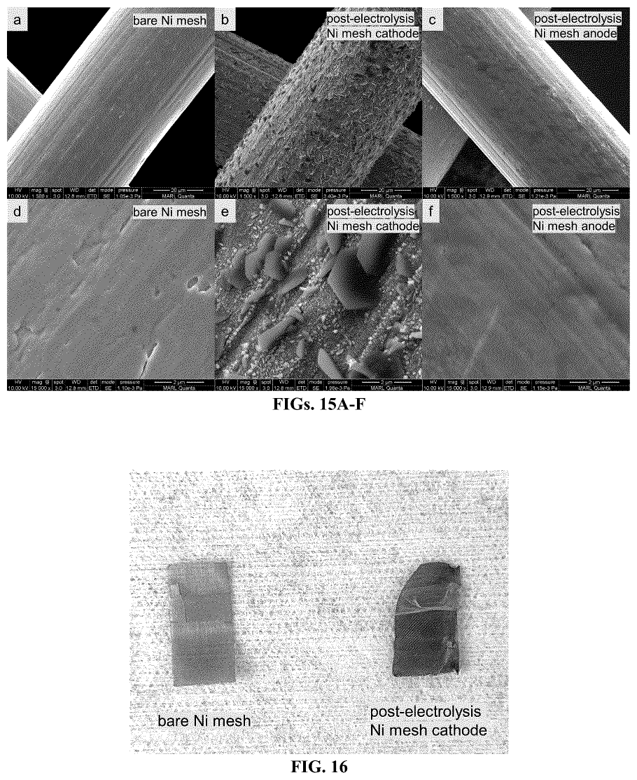

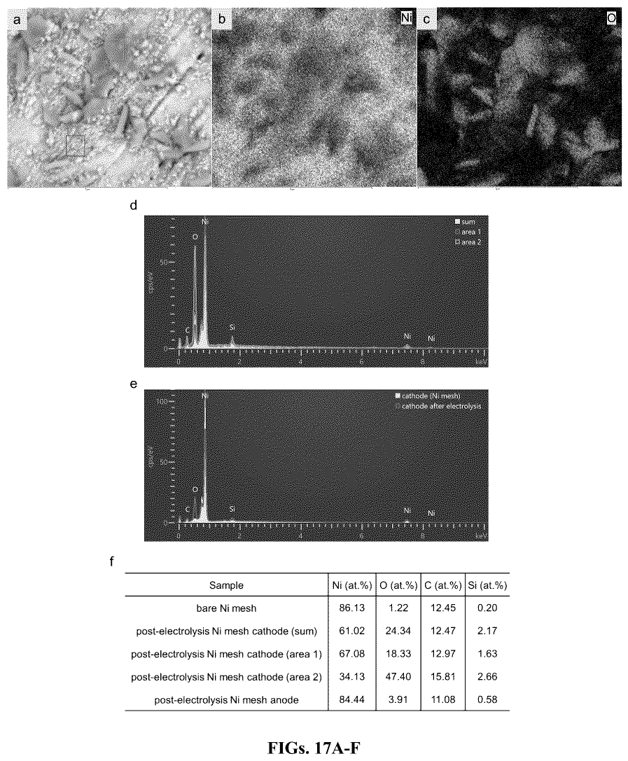

Notably, the re-deposition of partially oxidized nickel species on cathode was observed during electrolysis, which extends the electrochemical surface area contributing to the high-performance NO₃⁻-to-NH₃ conversion. While no substantial change was found on the anode in the post-electrolysis characterization by scanning electron microscopy (SEM), the formation of nanoparticles in ˜100 nm and larger hexagonal flakes in 1-2.5 μm was found on the cathode (FIG. 6B and FIGS. 15A-F), in accordance with the observed darkening of the cathode subject to electrolysis (FIG. 16).

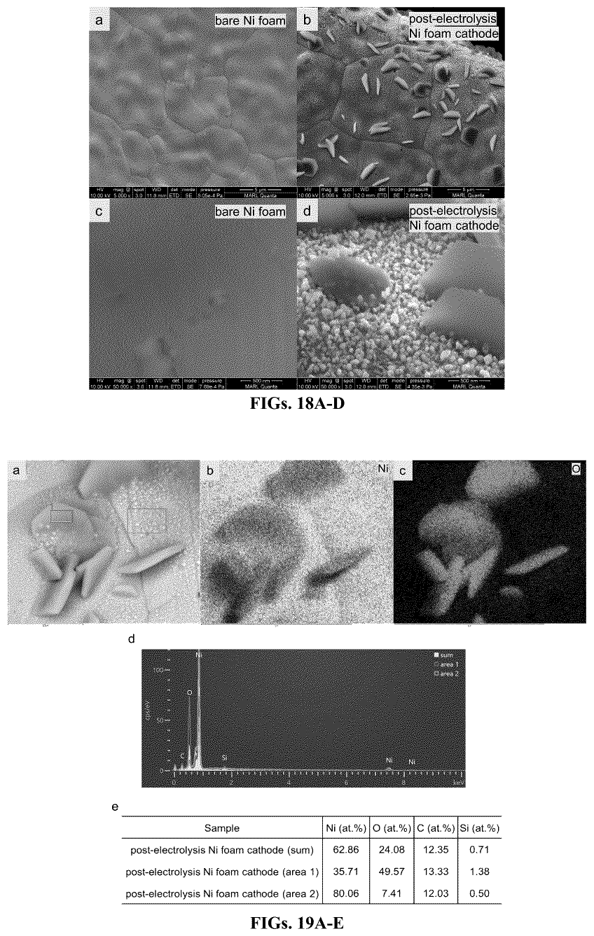

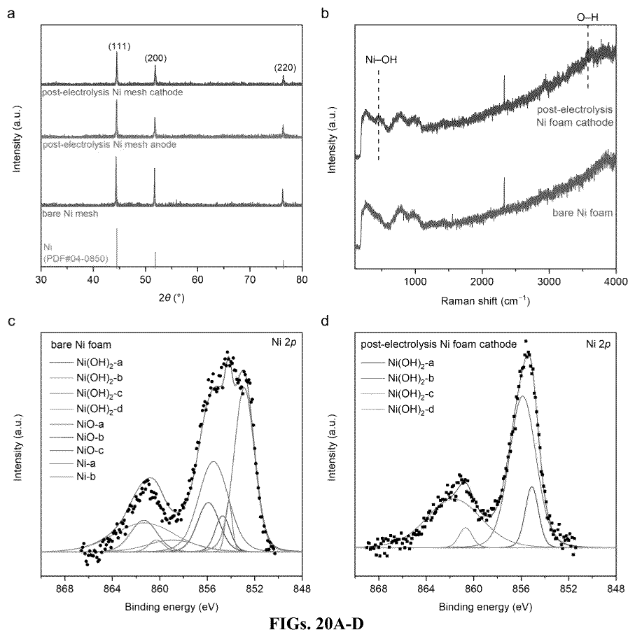

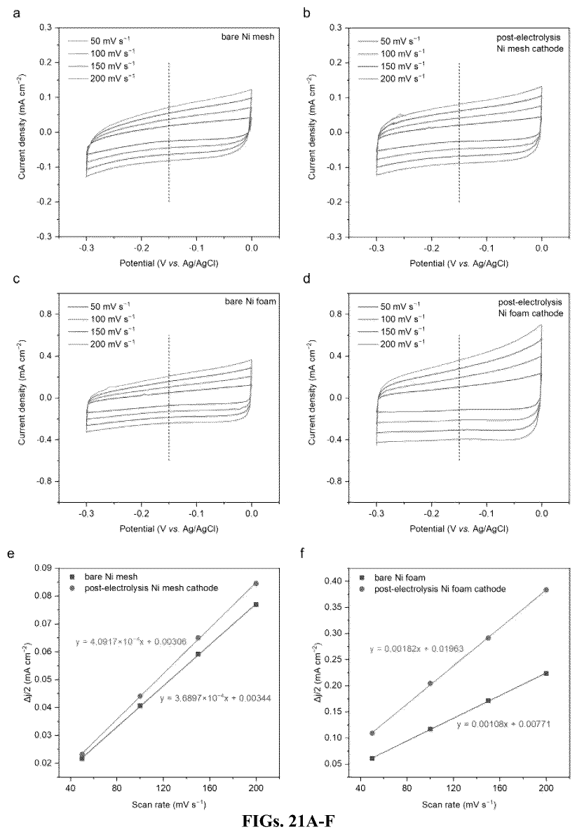

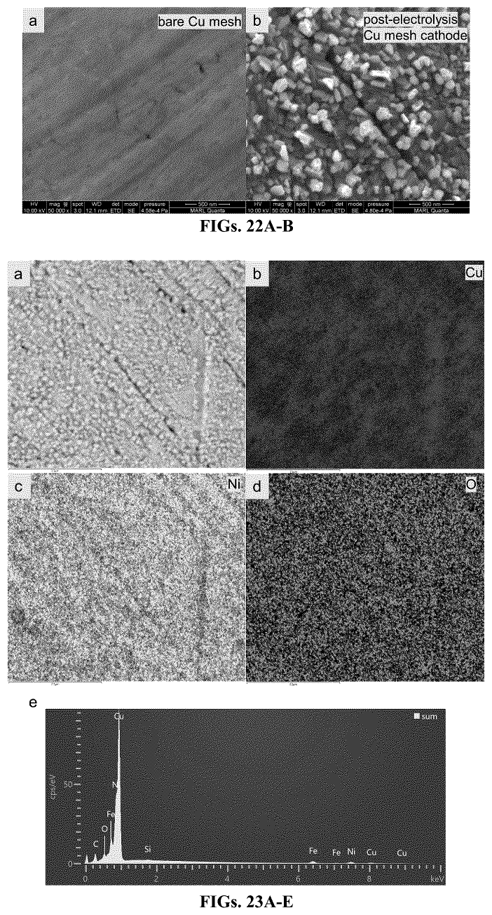

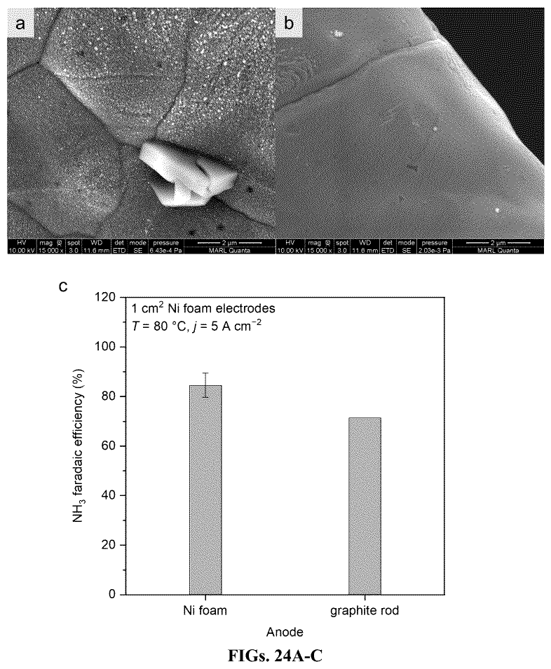

The energy-dispersive X-ray spectroscopy (EDS) analysis reveals the Ni/O atomic ratio of 3.66 and 0.72 on the nanoparticles respectively; and an overall increase in oxygen content from 1.2 at. % before electrolysis to 24.3 at. % afterwards (FIGS. 17A-F, FIGS. 18A-D, FIGS. 19A-E). The surface of the post-electrolysis cathode includes a layer of Ni(OH)₂, as suggested by XPS and Raman spectra (FIGS. 20A-D). These deposits increased the roughness factor (RF) of Ni cathode by 1.11 and 1.69 times for Ni mesh and Ni foam, respectively (FIGS. 21A-F), which should be a contributor to the enhancement of NO3RR activity.

The formation of those cathodic deposits should come from the migration of Ni from the anode to the cathode during electrolysis (namely, re-deposition): anodic Ni is initially oxidized to Ni(OH)₂/NiOOH which is an active catalyst for the oxygen evolution reaction (OER) (Klaus et al., J. Phys. Chem. C 119:7243-7254 (2015), which is hereby incorporated by reference in its entirety), followed by its partial dissolution in the strongly alkaline electrolyte in forms of Ni(OH)₃⁻ or Ni(OH)₄²⁻ (^{Y}e et al., Chem. Commun. 54:10116-10119 (2018), which is hereby incorporated by reference in its entirety); subsequently, these soluble Ni(II) species are re-deposited onto the cathode. When a Cu mesh was used as the cathode while keeping the Ni mesh as the anode, similar deposits were observed (FIGS. 22A-B, FIGS. 23A-E); however, when a graphite rod was used as the anode while using the Ni foam as the cathode, no deposit was observed after electrolysis (FIGS. 24A-C). Clearly, the two experiments verified that the origin of those deposits is the Ni anode. As such, the re-deposition of Ni-species in this work should be distinguished from the “cathodic corrosion” reported by Koper et al. (Yanson et al., Angew. Chem. Int. Ed. 50:6346-6350 (2011), which is hereby incorporated by reference in its entirety). Also, the re-deposition process is possibly associated with the higher cell voltage and lower FE towards NH₃ at the initial period of electrolysis (as shown in FIGS. 6A and 6C).

It should be noted that such a re-deposition occurs only within the near-surface region of the electrodes while the bulk composition of the electrodes remains largely unchanged, as evidenced by the X-ray diffraction (XRD) (FIG. 20A). This is also consistent with the very minor change in mass of the Ni electrodes (<1 mg) operated at 5 A for 2 hours. In real applications, the longevity of both Ni electrodes can be maintained by periodically reversing the current flow.

### Production of Pure NH₃-Based Chemicals from a Scale-Up MFAEL

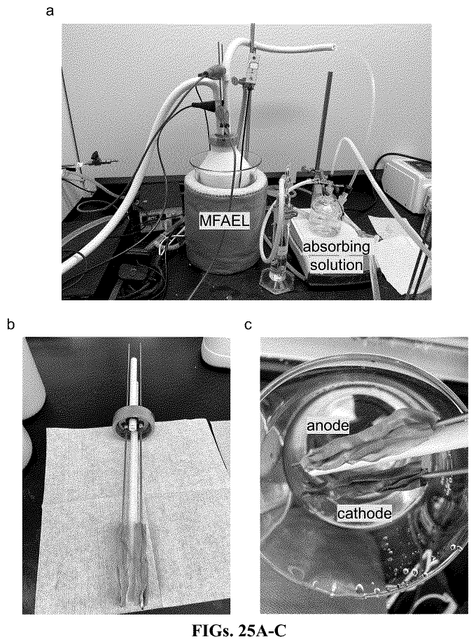

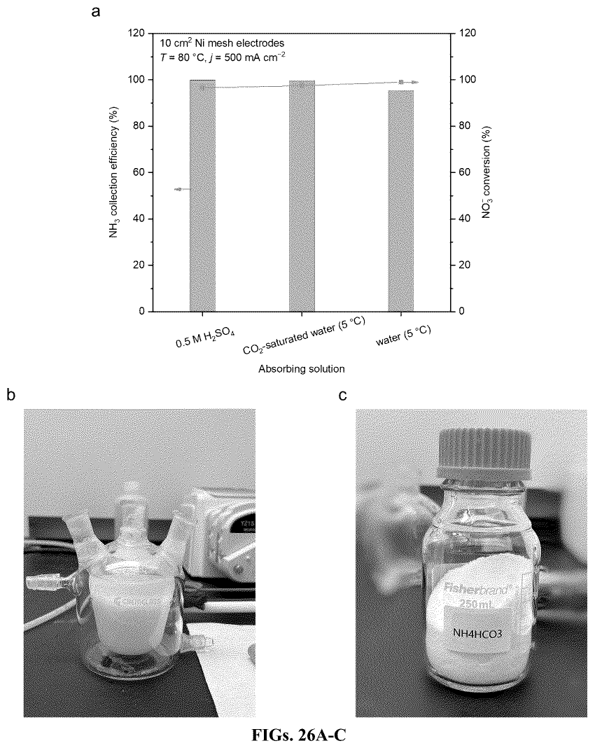

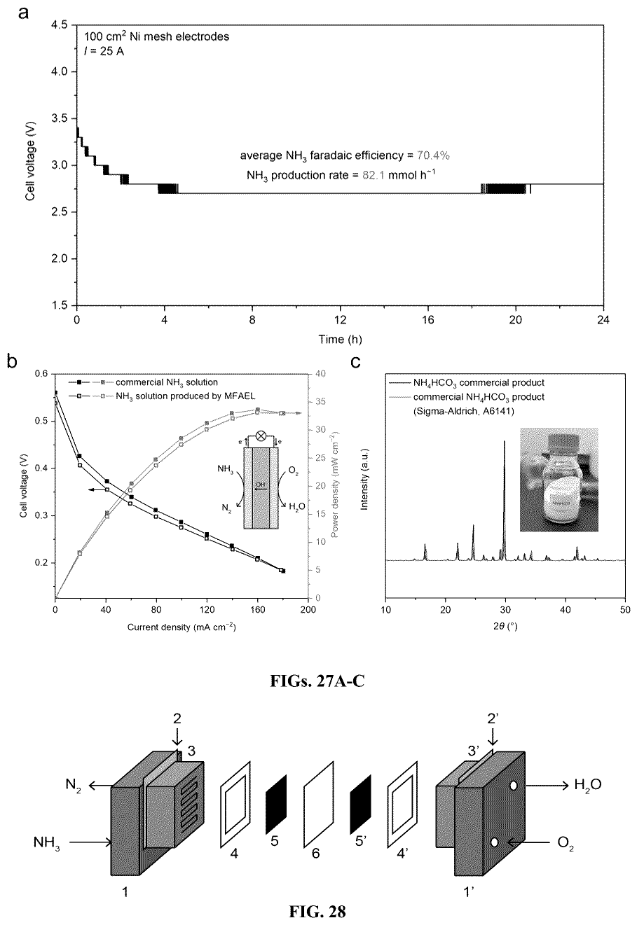

Thanks to the high activity and operational robustness of the MFAEL, the reaction capacity was increased from 100 mL to 2.5 L under industrial-relevant conditions (FIGS. 25A-C and FIGS. 26A-C). Two 100 cm² Ni mesh electrodes were folded and immersed in the electrolyte, and a constant current of 25 A was applied (i.e., 250 mA cm⁻²). With the scaled-up system, NO3RR was carried out for 24 hours, resulting in an average FE of 70.4% towards NH₃ and a steady-state cell voltage of 2.7 V (FIG. 27A). As a result, a very high NH₃ production rate of 82.1 mmol h⁻¹ was achieved in this scaled-up MFAEL reactor.

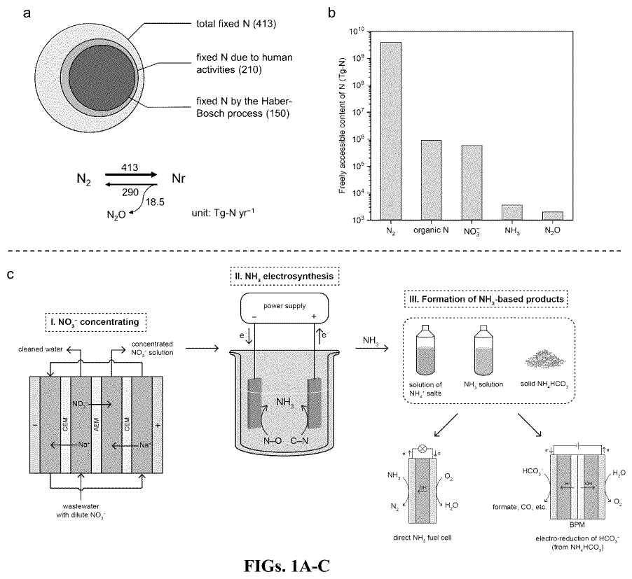

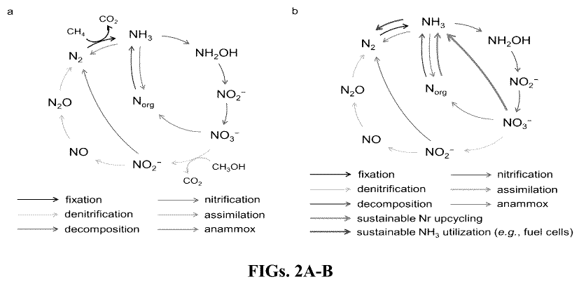

The produced NH₃ from the MFAEL can be managed in different forms: NH₄⁺ salts (such as sulfate), aqueous NH₃ solutions, and a solid NH₄HCO₃ product (FIG. 1C). When an acidic absorbing solution (e.g., H₂SO₄ solution) is used as for most measurements in this work, NH₄⁺ salts are the final products in solutions. The collection efficiency is almost 100% under varying conditions, as evidenced by the close-to-unity N balance for all tests (Table 2).

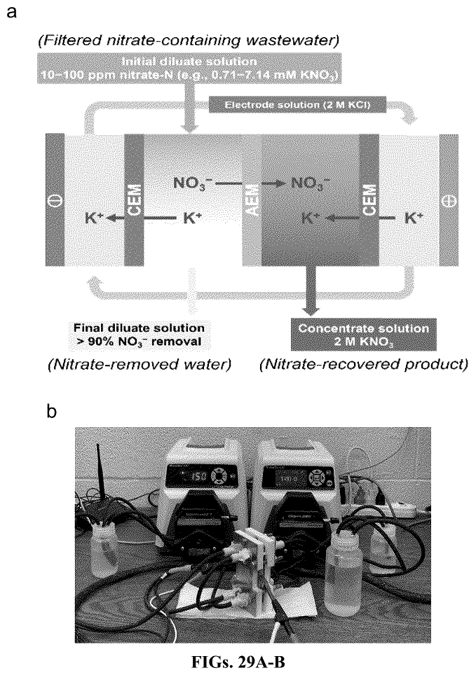

Alternatively, when water (5° C.) is used for NH₃ absorption, despite a slightly lower collection efficiency (95.6%) (FIG. 26A), a highly-concentrated NH₃ solution (4.13 M, or around 7 wt. %) was obtained after the 24-hour electrolysis from the scaled-up MFAEL. The MFAEL-derived NH₃ solution (with added 1.25 M KOH) was directly supplied as the anode fuel for an anion-exchange membrane fuel cell (FIG. 27B and FIG. 28), outputting a peak power density of 33.7 mW cm⁻² at 80° C., which is a reasonable performance among the reported values of direct NH₃ fuel cells using commercial catalysts, membranes, and ionomers (Jeerh et al., J. Mater. Chem. A 9:727-752 (2021), which is hereby incorporated by reference in its entirety). Notably, the I-V curve and power density profile show no significant difference between the fuel cells fed with MFAEL-derived NH₃ solution and that fed with a commercial NH₃ solution in the same concentration, suggesting the high purity of MFAEL-derived NH₃ solution.

In another case, the NH₃-containing outlet gas from MFAEL was absorbed by a CO₂-bubbling water solution at 5° C. Owing to the acidity of CO₂, NH₃ collection efficiency as high as 99.9% was achieved (FIG. 26A). Co-absorbing NH₃ and CO₂ in water allows for the simultaneous collection of NH₃ and the capture of waste CO₂, producing NH₄HCO₃ which can be precipitated easily due to its relatively low solubility (around 14.3 g in 100 mL water at 5° C.). Considerable precipitation of NH₄HCO₃ can be obtained from the absorbing solution after 24 hours of electrolysis in the scaled-up MFAEL, the high purity of which was confirmed by XRD (FIG. 27C and FIG. 26A). One further use of such NH₄HCO₃ involves a bicarbonate electrolyzer with a bipolar membrane, in which CO₂ is generated in situ and reduced to formate, CO, or other value-added products (Li et al., Joule 3:1487-1497 (2019); Liu et al., ACS Energy Lett. 7:4483-4489 (2022); which are hereby incorporated by reference in their entirety).

### A Convergent Nr-to-NH₃ Process Enabled by MFAEL

Thus far, the OER has been the anodic reaction in the investigated systems, which does not produce value-added products itself. Alternatively, a paired electrolysis system can be constructed by combining the reduction of NO₃ (on cathode) and oxidation of C—N bonds in organic Nr compounds (on anode) in one electrolytic cell (FIG. 4A). Organic Nr compounds (such as amino acids and proteins) represent a large portion of the global inventory of Nr (FIG. 1B), but their chemical conversion remains challenging owing to the high stability of C—N bonds (Pehlivanoglu-Mantas and Sedlak, Crit. Rev. Environ. Sci. Technol., 36:261-285 (2006), which is hereby incorporated by reference in its entirety). Organic Nr is also a significant contributor to NO₃⁻ (via the nitrification process) if left unattended in waste streams (Brennan et al., Environ. Sci. Water Res. Technol.7:259-273 (2021), which is hereby incorporated by reference in its entirety). Alternatively, a paired electrolysis system can be constructed by combining the reduction of NO₃⁻ (on cathode) and oxidation of C—N bonds in organic Nr (on anode) in one electrolytic cell (FIG. 4A). In such a system, organic Nr serves as an additional source of N for NH₃ production and provides electrons for NO₃⁻ reduction. Meanwhile, pairing organic Nr oxidation with NO₃⁻ reduction also switches the anode product from low-value O₂ (through OER) to value-added oxidized organic compounds such as carboxylic acids with the simultaneous release of NH₃, increasing economic feasibility.

To examine the NH₃ formation from organic Nr in NaOH/KOH/H₂O, a series of N-containing compounds was first screened with representative chemical environments of N element (12 organic Nr compounds and 3 inorganic Nr compounds) at 200° C. with an applied current density of 25 mA cm⁻² (FIG. 4B and Table 3). Note that most organic Nr compounds examined in this work are amino acids (listed in Table 3), which are common and major forms of organic N in the ecosystems (Berman and Bronk, Aquat. Microb. Ecol., 31:279-305 (2003), which is hereby, incorporated by reference in its entirety). Interestingly, except for EDTA (ethylenediaminetetraacetic acid) and TMG (trimethyl glycine), N from all other N-containing compounds (10 in organic Nr and 3 in inorganic Nr) examined in this work was completely converted to NH₃ in its final form within a few hours of electrolysis. Compared to inorganic Nr (with N—O bonds), organic Nr compounds require longer reaction time for full conversion, because of the higher stability of C—N bonds (W. M. Haynes, CRC Handbook of Chemistry and Physics, CRC Press (2016), which is hereby incorporated by reference in its entirety). N atoms connected with longer carbon chains, conjugated structures, or more than two adjacent C atoms appear to be less reactive, though in most cases they can ultimately be converted to NH₃. The high Nr conversion and high NH₃ selectivity enable a convergent pathway from various forms of Nr towards NH₃ as the sole N-containing product.

TABLE 3
Summary of the screening test results in the NaOH/KOH/H₂O electrolyte in this work. All tests were conducted at 25
mA cm⁻² at 200° C., and NH₃ was collected every half hour until no significant increase in its production was detected.

| | Added | | | N content | Added N | NH₃ production | NH₃—N | Electrolysis |
|---|---|---|---|---|---|---|---|---|
| Entry | sample | Abbreviation | Structure | (wt. %) | (mmol) | (mmol) | recovery (%) | time (h) |
| 1 | (NH₄)₂SO₄ | — | 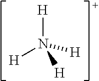 | 21.2 | 0.207 | 0.230 | 111.3 | 1 |
| 2 | KNO₃ | — | 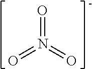 | 13.8 | 0.201 | 0.200 | 99.3 | 2 |
| 3 | KNO₂ | — | 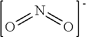 | 16.5 | 0.222 | 0.227 | 102.1 | 2.5 |
| 4 | Urea | — | 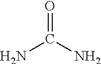 | 46.6 | 0.204 | 0.207 | 101.3 | 5 |
| 5 | Glycine | Gly | 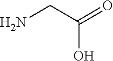 | 18.6 | 0.205 | 0.193 | 94.2 | 3.5 |
| 6 | Lysine | Lys | | 19.2 | 0.204 | 0.203 | 99.4 | 8.5 |
| 7 | Arginine | Arg | | 32.1 | 0.201 | 0.190 | 94.3 | 8 |
| 8 | Proline | Pro | 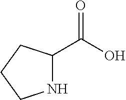 | 12.2 | 0.216 | 0.236 | 109.1 | 3 |
| 9 | Ethylenediamine- | EDTA | | 9.58 | 0.201 | 0.0100 | 4.99 | 2[a] |
| | tetraacetic | | | | | | | |
| | acid | | | | | | | |
| 10 | Trimethylglycine | TMG | 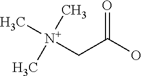 | 12.0 | 0.198 | 0.00436 | 2.20 | 2[a] |
| 11 | Histidine | His | | 27.1 | 0.207 | 0.224 | 108.1 | 4 |
| 12 | Tryptophan | Trp | | 13.7 | 0.188 | 0.180 | 95.7 | 7 |
| 13 | Adenine | Ade | 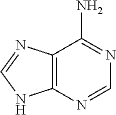 | 51.8 | 0.203 | 0.190 | 93.6 | 6.5 |
| 14 | Algae powder | — | — | 11.5 | 0.202 | 0.218 | 108.0 | 6.5 |
| 15 | Protein | — | | 8.90 | 0.197 | 0.193 | 98.0 | 7 |
| | powder | | | | | | | |

[a]For Entry 9 (EDTA) and 10 (TMG), the electrolysis was terminated at 2 h, because of the very low NH₃ production rate.

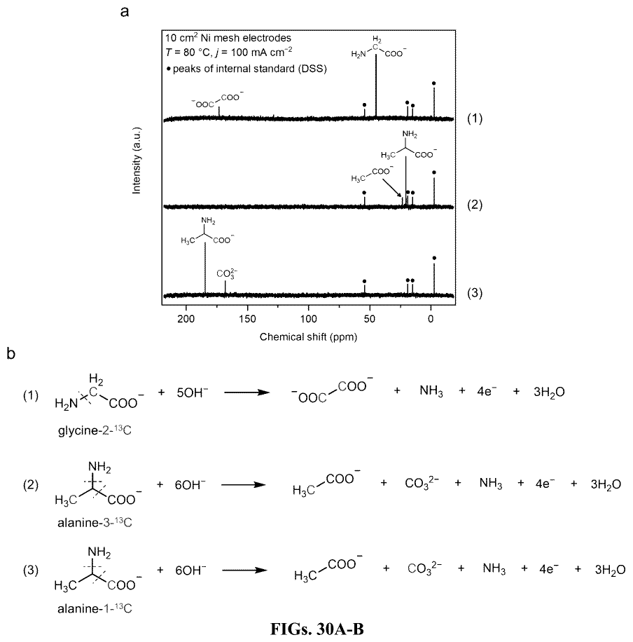

The products after the cleavage of C—N bonds in NaOH/KOH/H₂O was then investigated (FIGS. 30A-B). Glycine and alanine were chosen as the reactants due to their structural simplicity, and electrolysis was performed at 80° C. To track the carbon-containing products, ¹³C-labeled chemicals were used as the reactants, and the products were analyzed by ¹³C nuclear magnetic resonance (NMR) spectroscopy. The results show that the oxidations of both organic Nr compounds are 4-electron-transfer processes, in which the C—N bond scission is accompanied by the oxidation of the C element and the release of NH₃. Upon the cleavage of the C—N bond, the identified product for glycine oxidation was oxalate; while for alanine, a subsequent decarboxylation occurs, giving rise to acetate and carbonate (eqn (2) and (3) below):

H₂N—CH₂—COO⁻ (glycine)+5OH⁻→C₂O₄²⁻+NH₃+3H₂O+4e⁻ (2)

H₂N—CH(CH₃)—COO⁻ (alanine)+6OH⁻→CH₃COO⁻+CO₃²⁻+NH₃+3H₂O+4e⁻ (3)

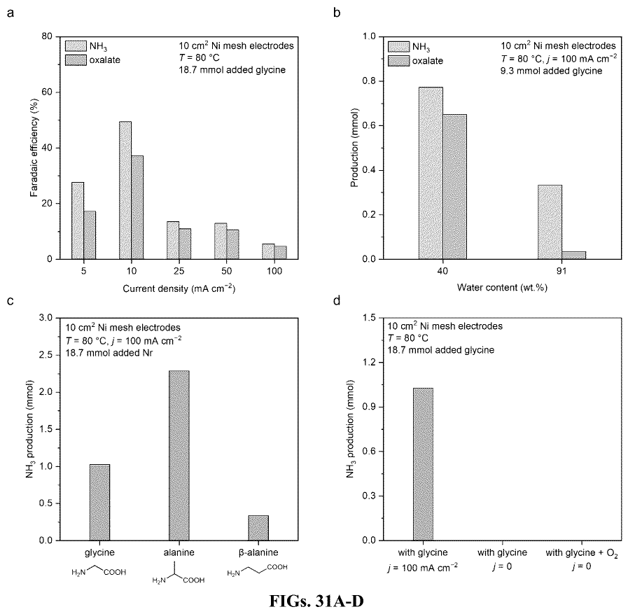

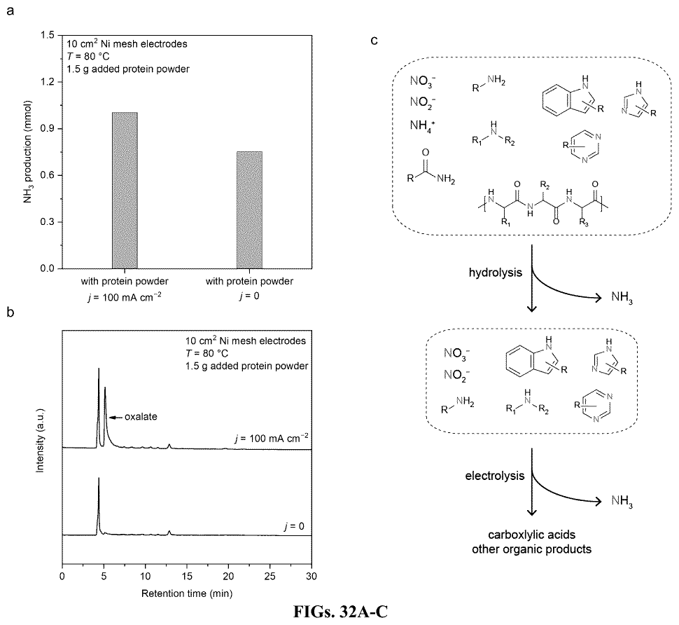

Similar results should be expected for Nr in more complex structures, demonstrating that MFAEL is capable of converting organic N-containing wastes into value-added carboxylic acid products, while largely retaining the skeleton of the original molecules. Additional experimental results (detailed in FIGS. 31A-D, FIGS. 32A-C) confirmed that both applied electricity and high alkalinity are indispensable conditions for the reaction to proceed efficiently in MFAEL. In the presence of organic Nr, production of O₂ from OER is apparently suppressed as confirmed by online GC (FIGS. 33A-B). Interestingly, none of the volatile carbon-containing products (CO, CH₄, CO₂, C₂H₂, C₂H₄, and C₂H₆) was detected by online GC during the conversion of organic Nr (FIGS. 34A-C), indicating that carbon is retained in the electrolyte.

Knowing that NH₃ can be produced via the oxidation-assisted cleavage of C—N bonds, the reduction of N—O bonds was paired with the oxidation of C—N bonds, aiming to generate NH₃ from both sources (FIG. 4C and FIGS. 35A-D). For this purpose, KNO₃ and alanine were added into MFAEL as model reactants containing N—O and C—N bonds:

2H₂N—CH(R)—COO⁻+NO³⁻+3OH⁻→2R—COO⁻+2CO₂²⁻+3NH₃ (4)

Notably, to determine the respective contribution of NH₃ production from each source, the N—O reactant was isotopically labeled using K¹⁵NO₃, and the NH₃ product was analyzed by ¹H NMR to differentiate ¹⁴NH₃ and ¹⁵NH₃. With this configuration operated at 100 mA cm⁻², ¹H NMR suggests that the produced NH₃ is derived from both N—O reduction and C—N oxidation with their corresponding FE of 72.3% and 52.1%, respectively (FIG. 4C). Based on the quantification of reactants and products, the elemental balance of nitrogen and carbon was 87.8% and 80.0%, respectively (detailed in FIGS. 36A-C), suggesting that eqn (4) is a reasonable description of the paired process. Considering the abundance of organic Nr in the wastes from certain industries such as meat processing facilities (Bustillo-Lecompte and Mehrvar, J. Environ. Manage. 161:287-302 (2015; Brennan et al., Environ. Sci. Water Res. Technol.7:259-273 (2021); which are hereby incorporated by reference in their entirety), this “one-pot” strategy for converting various Nr into NH₃ not only improves the utilization of electrons, but also mitigates the cost of reactant separation and purification for complex real waste matrices.

### Conclusions

In this work, an integrated sustainable process was presented for economically upcycling waste nitrogen. In particular, a versatile, robust, and inexpensive MFAEL system was developed to convert various forms of waste Nr into NH₃ convergently. Taking advantage of its strong tendency towards hydrogenating N—O bonds, a partial current density as high as 4.22±0.25 A cm⁻² for NH₃ production was achieved by NO₃⁻ reduction without generating considerable N—N coupling products.

Upscaling the MFAEL system is straightforward due to its structural simplicity and inexpensiveness of its components. The 2.5 L scaled-up reactor is capable of producing NH₃ at 25 A with an average FE of 70.4% from NO3RR. By properly choosing the NH₃ absorbing condition, different forms of pure NH₃-based chemicals (NH₄⁺ salts, NH₃ solution, and solid NH₄HCO₃) can be continuously produced from the conversion of waste Nr in MFAEL. Since the NH₃ product from MFAEL is in a gas mixture, pure NH₃ gas can be obtained through established economical gas separation technologies (such as pressure swing adsorption) without the need for additional distillation steps (Wang et al., Energy Environ Sci 14:2535-2548 (2021), which is hereby incorporated by reference in its entirety). Use of organic or inorganic additives could increase the co-absorption efficiency of MFAEL-derived NH₃ and waste CO₂ (Wang et al., Appl. Energy 230:734-749 (2018), which is hereby incorporated by reference in its entirety), making it a promising dual-purpose process that fixes waste N and C into one useful chemical product NH₄HCO₃. The resemblance of MFAEL configuration to the alkaline water electrolyzers (typically operated at 70-90° C. with 25-35 wt. % of KOH solutions (Guillet and Millet, in Hydrogen Production, pp. 117-166 (2015), which is hereby incorporated by reference in its entirety)) has suggested a clear potential towards commercialization, since the latter has been commercially available for over 50 years.

The feasibility of concentrating NO₃⁻ by a low-energy cost electrodialysis process was validated both experimentally and analytically via a comprehensive TEA study. Combining NO₃⁻ concentrating by electrodialysis and its reduction in MFAEL generates a competitive levelized total cost of the waste-derived NH₃ product, largely owing to the remarkably low material cost of the MFAEL system.

In the experiments described herein, Ni was chosen as the electrode material primarily due to its inexpensiveness and its excellent corrosion resistance. Not limited to Ni, other metals such as Co, Ru, and Cu can also serve as the cathode in the KOH/NaOH/H₂O electrolyte, and their performance comparison under the same test conditions is shown in FIG. 37.

In the NaOH/KOH/H₂O electrolyte, C—N bonds in organic Nr compounds can be oxidized to produce NH₃. By controlling the operating conditions of MFAEL, ˜100% recovery of most common forms of Nr into NH₃ can be realized, making it a sensitive and accurate tool for determining N content in complex real-world samples. Oxidation of C—N bonds results in the production of carboxylic acids as a potentially value-added by-product, and pairing the oxidation of C—N bonds (on anode) with the reduction of N—O bonds (on cathode) in MFAEL leads to a cathodic and anodic FE of 72.3% and 52.1% for NH₃ production at 100 mA cm⁻², respectively, demonstrating its capability of extracting N element from real waste containing both oxidative and reductive forms of Nr.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A membrane-free alkaline electrolyzer (MFAEL) system for converting nitrogen (N)-containing waste into ammonia (NH₃), said system comprising:
a reaction medium comprising H₂O—NaOH—KOH;
a pair of electrodes, wherein the electrodes are in contact with the reaction medium; and
a power supply operably connected to the electrodes.

2. The system according to claim 1, wherein the H₂O is present in the reaction medium in an amount of about 40 wt. %.

3. The system according to claim 1, wherein the reaction medium comprises equimolar of NaOH and KOH.

4. The system according to claim 1, wherein the reaction medium has a temperature of about 80-200° C.

5. The system according to claim 1, wherein the reaction medium has a temperature of about 80° C.

6. The system according to claim 1, wherein the electrodes are formed of a material comprising nickel.

7. The system according to claim 1, wherein the electrodes are nickel electrodes.

8. The system according to claim 1, wherein the reaction medium is contained in a leak-free reaction chamber.

9. The system according to claim 8, wherein the reaction chamber comprises:
a liquid injection conduit for adding water and/or nitrogen (N)-containing waste into the reaction chamber.

10. The system according to claim 9, wherein the reaction chamber further comprises:
an air intake conduit for adding N₂ into the reaction medium;
an exit conduit for removing ammonia (NH₃) from the reaction medium.

11. The system according to claim 8, wherein the reaction chamber is constructed of polytetrafluoroethylene (PTFE).

12. The system according to claim 8, wherein the reaction chamber comprises a stainless steel cap.

13. The system according to claim 8, further comprising:
an oil bath for heating the reaction chamber.

14. The system according to claim 1, wherein the nitrogen (N)-containing waste is selected from nitrate, nitrite, urea, amino acids, proteins, and mixtures thereof.

15. The system according to claim 1, further comprising:
a container for collecting ammonia (NH₃) produced by the system, wherein the container comprises an absorbing solution.

16. The system according to claim 15, wherein the absorbing solution comprises H₂SO₄.

17. A method for converting nitrogen (N)-containing waste into ammonia (NH₃), said method comprising:
introducing nitrogen (N)-containing waste into a membrane-free alkaline electrolyzer (MFAEL) system comprising:
a reaction medium comprising H₂O—NaOH—KOH;
a pair of electrodes, wherein the electrodes are in contact with the reaction medium; and
a power supply operably connected to the electrodes and
applying a current between the electrodes to perform oxidative and reductive transformation of the nitrogen (N)-containing waste into ammonia (NH₃).

18. The method according to claim 17, wherein the nitrogen (N)-containing waste is selected from nitrate, nitrite, urea, amino acids, proteins, and mixtures thereof.

19. The method according to claim 17, wherein the H₂O is present in the reaction medium in an amount of about 40 wt. %.

20. The method according to claim 17, wherein the reaction medium comprises equimolar of NaOH and KOH.

21-40. (canceled)
